(19) United States
(12) Patent Application Publication
(10) Pub. No.: US 2026/0270054 A1
(43) Pub. Date: Sep. 10, 2026

(54) CLASSICAL CRYPTOGRAPHY AND POST-QUANTUM CRYPTOGRAPHY AUTHENTICATION FOR VEHICLE-TO-EVERYTHING (V2X) COMMUNICATION

(71) Applicant: QUALCOMM Incorporated, San Diego, CA (US)

(72) Inventors: William WHYTE, Natick, MA (US); James Alan MISENER, San Diego, CA (US); Vincent Douglas PARK, Alexandria, VA (US); Sean Vincent MASCHUE, Encinitas, CA (US); Virendra KUMAR, Sudbury, MA (US)

(21) Appl. No.: 19/559,821

(22) Filed: Mar. 6, 2026

Related U.S. Application Data
(60) Provisional application No. 63/769,661, filed on Mar. 10, 2025.

(51) Int. Cl. H04L 9/08; H04L 9/32

(52) U.S. Cl. CPC H04L 9/0852; H04L 9/3226; H04L 9/3268

(57) ABSTRACT

Disclosed are systems, apparatuses, processes, and computer-readable media for classical cryptography and post-quantum cryptography (PQC) protection for V2X communication. For example, an apparatus includes a processor and a memory coupled to the processor. The processor is configured to: generate a first message of a first type; generate a first authentication code for the first message with a first type of authentication key based on the first message being of the first type; generate a second message of a second type; and generate a second authentication code for the second message with a second type of authentication key based on the second message being of the second type, wherein the second type of authentication key is based on PQC.

### CROSS REFERENCE TO RELATED PATENT APPLICATION

This application claims priority to U.S. Provisional Patent Application Ser. No. 63/769,661 titled “CLASSICAL CRYPTOGRAPHY AND POST-QUANTUM CRYPTOGRAPHY AUTHENTICATION FOR V2X COMMUNICATION,” filed on Mar. 10, 2025, which is incorporated herein by reference in its entirety for all purposes.

### FIELD

The present disclosure generally relates to protecting information using cryptographic functions. For example, aspects of the present disclosure relate to selectively performing classical cryptography and post-quantum cryptography for protecting information (e.g., vehicle-to-everything (V2X) communications, such as V2X messages).

### BACKGROUND

Wireless communication systems (e.g., based on telecommunications and intelligent transportation systems standards) are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards and in intelligent transportation systems standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. Aspects of wireless communication may comprise direct communication between devices, such as in V2X, vehicle-to-vehicle (V2V), and/or device-to-device (D2D) communication. There exists a need for further improvements in V2X, V2V, and/or D2D technology. These improvements may also be applicable to other multi-access technologies and the telecommunication standards that employ these technologies.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, apparatuses, methods, and computer-readable media for wireless communication. In some aspects, an apparatus is provided for protecting information. The apparatus includes a memory; and a processor coupled to the memory and configured to: generate a first message of a first type; generate a first authentication code for the first message with a first type of authentication key based on the first message being of the first type; generate a second message of a second type; and generate a second authentication code for the second message with a second type of authentication key based on the second message being of the second type, wherein the second type of authentication key is based on PQC.

In some aspects, a method is provided for protecting information. The method includes: generating a first message of a first type; generating a first authentication code for the first message with a first type of authentication key based on the first message being of the first type; generating a second message of a second type; and generating a second authentication code for the second message with a second type of authentication key based on the second message being of the second type, wherein the second type of authentication key is based on post-quantum cryptography (PQC).

In some aspects, a non-transitory computer-readable medium is provided having stored thereon instructions that, when executed by at least one processor, cause the at least one processor to: generate a first message of a first type; generate a first authentication code for the first message with a first type of authentication key based on the first message being of the first type; generate a second message of a second type; and generate a second authentication code for the second message with a second type of authentication key based on the second message being of the second type, wherein the second type of authentication key is based on PQC.

In some aspects, an apparatus is provided for protecting information. The apparatus includes: means for generating a first message of a first type; means for generating a first authentication code for the first message with a first type of authentication key based on the first message being of the first type; means for generating a second message of a second type; and means for generating a second authentication code for the second message with a second type of authentication key based on the second message being of the second type, wherein the second type of authentication key is based on post-quantum cryptography (PQC).

In some aspects, the apparatus is, includes, or is part of, a vehicle (e.g., an automobile, truck, etc., or a component or system of an automobile, truck, etc.) or a device or component of the vehicle, a mobile device (e.g., a mobile telephone or so-called “smart phone” or other mobile device), a wearable device, an extended reality device (e.g., a virtual reality (VR) device, an augmented reality (AR) device, or a mixed reality (MR) device), a personal computer, a laptop computer, a server computer, a robotics device, or other device. In some aspects, the apparatus includes radio detection and ranging (radar) for capturing radio frequency (RF) signals. In some aspects, the apparatus includes one or more light detection and ranging (LIDAR) sensors, radar sensors, or other light-based sensors for capturing light-based (e.g., optical frequency) signals. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors, which can be used for determining a location of the apparatuses, a state of the apparatuses (e.g., a temperature, a humidity level, and/or other state), and/or for other purposes.

This summary is not intended to identify key or essential features of the claimed subject matter, nor is it intended for use in isolation to determine the scope of the claimed subject matter. The subject matter should be understood by reference to appropriate portions of the entire specification of this patent, any or all drawings, and each claim.

Other objects and advantages associated with the aspects disclosed herein will be apparent to those skilled in the art based on the accompanying drawings and detailed description.

### BRIEF DESCRIPTION OF THE DRAWINGS

Illustrative aspects of the present application are described in detail below with reference to the following figures:

FIG. 1 is a diagram of a vehicle 100 and various V2X functions of the vehicle in accordance with some aspects of the disclosure;

FIG. 2 is a diagram illustrating an example wireless communication configuration in accordance with some aspects of the present disclosure;

FIG. 3 is a diagram illustrating an example wireless communications system in accordance with some aspects of the present disclosure;

FIG. 4 is a diagram illustrating an example of a disaggregated base station architecture in accordance with some aspects of the present disclosure;

FIG. 5 is a block diagram illustrating an example of a computing system of a vehicle in accordance with some aspects of the present disclosure;

FIG. 6 is a flow diagram illustrating a process for cryptographically protecting V2X communications in accordance with some aspects of the disclosure;

FIG. 7 is a flow diagram illustrating a process for selecting a type of authentication for V2X communication in accordance with some aspects of the disclosure;

FIG. 8 illustrates an example process for classifying a message to support selection of a cryptographic technique in accordance with some aspects of the disclosure; and

FIG. 9 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Various types of information (e.g., V2X communications, such as V2X messages) can be protected to prevent malicious actors from adversely affecting systems that utilize the information. For example, wireless communications systems are deployed to provide various telecommunication and/or intelligent transportation services, including telephony, video, data, messaging, broadcasting, among others. Vehicles are an example of systems that can include wireless communications capabilities. For example, vehicles (e.g., automotive vehicles, autonomous vehicles, aircraft, maritime vessels, among others) can communicate with other vehicles and/or with other devices that have wireless communications capabilities. Wireless vehicle communication systems encompass vehicle-to-vehicle (V2V), vehicle-to-infrastructure (V2I), vehicle-to-network (V2N), and vehicle-to-pedestrian (V2P) communications, which are all collectively referred to as vehicle-to-everything (V2X) communications. V2X communications is a vehicular communication system that supports the wireless transfer of information from a vehicle to other entities (e.g., other vehicles, pedestrians with smart phones, equipped vulnerable road users (VRUs), such as bicyclists, and/or other traffic infrastructure) located within the traffic system that may affect the vehicle. The main purpose of the V2X technology is to improve road safety, fuel savings, and traffic efficiency.

The IEEE 802.11p Standard supports a dedicated short-range communications (DSRC) interface for V2X wireless communications. Characteristics of the IEEE 802.11p based DSRC interface include low latency and the use of the unlicensed 5.9 Gigahertz (GHz) frequency band. C-V2X was adopted as an alternative to using the IEEE 802.11p based DSRC interface for the wireless communications. The 5G Automotive Association (5GAA) supports the use of C-V2X technology. In some cases, the C-V2X technology uses Long-Term Evolution (LTE) as the underlying technology, and the C-V2X functionalities are based on the LTE technology. C-V2X includes a plurality of operational modes. One of the operational modes allows for direct wireless communication between vehicles over the LTE sidelink PC5 interface. Similar to the IEEE 802.11p based DSRC interface, the LTE C-V2X sidelink PC5 interface operates over the 5.9 GHz frequency band. Vehicle-based messages, such as Basic Safety Messages (BSMs) and Cooperative Awareness Messages (CAMs), which are application layer messages, are designed to be wirelessly broadcasted over the 802.11p based DSRC interface and the LTE C-V2X sidelink PC5 interface.

Malicious actors can adversely affect traffic in a V2X system and can increase congestion, cause collisions involving autonomous vehicles, cause phantom vehicles to be present in the network to affect traffic, interfere with vehicle safety and increase safety risks, grant unauthorized access to vehicle systems, and so forth. Strong cryptography may be necessary to protect the various types of information. For example, strong authentication may be needed for protecting V2X communication to ensure that autonomous and semi-autonomous systems work safely, reduce congestion, and provide efficient usage of traffic infrastructure.

Conventional cryptographic techniques use hard problems in number theory as the mathematical basis for cryptographic algorithms such as Elliptic Curve Cryptography (ECC) and RSA (Rivest-Shamir-Adelman). Hard problems in number theory are the basis of classical cryptography because they allow the creation of algorithms which compute in one direction but are extremely hard to reverse without a special key. For example, hard problems include integer factorization, discrete logarithms, and elliptic curve discrete log. The difficulty of solving these problems ensures the security of cryptographic schemes against attacks using conventional processors.

In some aspects, quantum computers can break classical cryptography (e.g., hard problems in number theory such as integer factorization, discrete logarithms, and elliptic curve mathematics) by solving problems that are computationally infeasible for classical computers. Shor's algorithm is an example of an algorithm that can be executed on a quantum computer to break classical cryptography. For instance, many communications systems use public-key cryptography to secure communications. Once quantum computers of sufficient capabilities (e.g., Cryptographically Relevant Quantum Computers, CRQC) are available, they will be able to break the most common currently used public-key cryptography algorithms. For example, given a public key for one of the available public-key cryptography algorithms, a CRQC will be able to obtain the private key in a certain amount of time (though not necessarily instantaneously). Having the private key will allow an attacker to decrypt messages, forge signatures, etc., so these algorithms will be unsuitable for use if the data they need to protect (e.g., by encrypting or authenticating it) has a lifetime longer than the expected time it will take an attacker to recover the private key using CRQC.

Alternatives to existing public-key cryptography algorithms exist and some are currently in the process of being standardized by the US National Institute of Standards and Technology (NIST). These algorithms are collectively referred to as post-quantum cryptography (PQC). PQC is based on quantum-resistant mathematical foundations that use hard problems that are believed to be difficult for both classical and quantum computers. One example of a hard problem for PQC is a lattice-based problem, which involves finding specific points or structures within a high-dimensional grid (e.g., lattice) that are computationally hard to solve. Another example of a hard problem for PQC is code-based cryptography which relies on the hardness of decoding random linear codes. Code-based cryptography relies on the difficulty of decoding a random linear code and uses a public key generated by selecting a large error-correcting code and applying a series of random invertible transformations. Decoding random codes is exponential in complexity and is resistant to PQC algorithms.

However, it is infeasible to implement PQC for all communications (e.g., V2X communications). For example, V2X communications require low-latency and high-throughput. Current PQC algorithms struggle with low-latency and high-throughput operations due to computational overhead and larger key sizes as compared to classical cryptographic algorithms. In addition, the larger key sizes significantly contribute to bandwidth consumption, which increases latency with V2X communications. In addition, existing infrastructure supporting V2X communications, including roadside units and cellular networks, would require significant upgrades to support PQC without disrupting service.

For example, all of the PQC algorithms currently under consideration have the property that their keys, ciphertexts, and signatures are considerably larger than existing public key algorithms and so require more space to transmit, more memory to process, etc. In some settings, such as V2X direct communications, there are many individual public-key signed messages sent per second and the capacity of the dedicated communications channel (e.g., the spectrum) is limited, so that a significant increase in signature and key size, resulting in a significant increase in packet size, will significantly increase the risks that the channel becomes congested and that messages are not received successfully. For any system for which public key cryptographic overhead is a significant contributor to traffic, the transition to PQC will therefore significantly increase the capacity needed for smooth operation of the system and, if the capacity is fixed and limited, the transition to PQC might make correct operation (to pre-quantum performance goals) impossible.

Systems, apparatuses, electronic devices, methods (also referred to as processes), and computer-readable media (collectively referred to herein as “systems and techniques”) are described herein for protecting information (e.g., V2X communications, such as V2X messages) based on different cryptographic techniques. While various examples described herein refer to vehicle communications (e.g., V2X communications) for illustrative purposes, the systems and techniques can be used for any type of information and systems that utilize such information.

For example, a scenario for which public key cryptography is particularly suited is where multiple senders, who need to be trusted, are communicating in a dynamic and ad-hoc fashion such that there will frequently and somewhat unpredictably be new receivers, and the new receivers need to quickly establish that new senders (from the new perspective of the new receivers) can be trusted. A standard mechanism (referred to herein as “classical cryptography,” a “classical cryptography algorithm,” etc.) for such authentication is public key certificates, where a sender has a public/private key pair and signs the message using its private key so it can be verified by another party with the public key, and the public key is approved by a certificate authority (CA) that creates a certificate. A certificate is a special format of signed message containing the public key of the end-entity (the message sender). The CA public key verifies the certificate, the sender's public key is in the certificate, and the sender's public key verifies the message. It is noteworthy that the CA public key is naturally somewhat long-lived but that the sender's public key need not be so long-lived.

The systems and techniques described herein can use different cryptographic techniques using multiple cryptographic algorithms. For instance, the systems and techniques can generate a first authentication code (e.g., a first message authentication code (MAC), a digital signature, a keyed hash value, an authentication tag generated using an authenticated encryption scheme, a cryptographic checksum, or another cryptographically generated authentication value, etc.) for the first message with a first type of authentication key based on the first message being of the first type. In one example, the first type of authentication key may be based on classical cryptography algorithms, such as public key certificates described above (e.g., using Elliptic Curve Digital Signature Algorithm (ECDSA) signatures), the Rivest-Shamir-Adleman (RSA) algorithm, elliptic curve cryptography (ECC), etc. The systems and techniques can generate a second authentication code (e.g., a second MAC) for the second message with a second type of authentication key based on the second message being of the second type. In some aspects, the second type of authentication key may be based on PQC, such as a Modular-Lattice digital signature algorithm (ML-DSA), Falcon DSA (FN-DSA), etc. Different factors may be used to determine how different messages are cryptographically protected, including the choice of algorithm for the authentication key. One factor includes a lifespan of the message, which is duration of time during which the confidentiality, integrity, authenticity, and/or operational relevance of the content is the message required to remain protected against compromise, unauthorized disclosure, and/or misuse. For example, high value content having a long lifespan (e.g., measured in years) may be protected using PQC, and lower value content or content having a very short lifespan (e.g., measured in seconds) may be protected using classical cryptography. In some aspects, as improvements to bandwidth and computational power increase, changes can be made to allow further messages to incorporate PQC.

The computational load associated with PQC may adversely affect latency, power consumption, and may not be backwards compatible for existing infrastructure nodes and devices. In addition, PQC adds a significant volume of bandwidth because the keys are larger than classical cryptographic keys. In some aspects, by having different cryptographic techniques for signals, additional layers of security can be integrated into various types of systems (e.g., V2X system) to protect different features and build in backwards compatibility to maximize usage of such systems.

In one illustrative example, the systems and techniques can use a first algorithm (e.g. algorithm A) that is not post-quantum (e.g., a classical cryptographic algorithm) and has small cryptographic overhead, and a second algorithm (e.g., algorithm B) that is post-quantum and has large cryptographic overhead. It can be assumed that quantum computers exist but in limited numbers. It can also be assumed that the time to break a specific key for algorithm A is finite but not instantaneous (e.g., it may take hours, days, or weeks rather than milliseconds). Based on these assumptions, for some period of time after a first CRQC comes into operation, and while in principle any key for algorithm A could be broken eventually, in practice, lower-value keys for algorithm A are very unlikely to be broken within a relatively short period of time (e.g., an hour, multiple hours, etc.) of becoming known to a potential attacker.

The systems and techniques described herein can operate in systems with multiple keys (e.g., a large number of keys), where some keys are used to carry out certain operations (e.g., relatively low-value operations, such as sending messages). The systems and techniques may continue to use vulnerable keys (e.g., related to classical cryptographic algorithms, which can be referred to as a quantum vulnerable key) for the low-value operations even when it is known that they can in principle be broken. As an instance, a quantum vulnerable key can be used to protect relatively low-impact information with a particular lifetime (e.g., a lifetime of a day), when keys of that strength have been known to have been broken (e.g., solved) in a timeframe that is longer than the particular lifetime (e.g., in a week). In one illustrative example, in a V2X setting, the systems and techniques can continue to use Elliptic Curve Digital Signature Algorithm (ECDSA) signatures to protect Basic Safety Messages (BSMs), and can use ML-DSA or the FN-DSA for higher-value operations, such as signing certificates, signing revocation lists, signing signal preemption messages, etc.

One advantage of such systems and techniques is that the overhead is significantly reduced compared to an approach that uses PQC for all signatures. For example, for a BSM, with all signatures being ECDSA (100 bytes), 10 BSMs a second, and two certificates a second, the total cryptographic overhead per sender per second is 1200 bytes. With BSM signatures being ECDSA (100 bytes) and certificate signatures being FN-DSA (1300 bytes), 10 BSMs and 2 certificates, the total cryptographic overhead per sender per second is 3600 bytes. With all signatures being FN-DSA (1300 byte signature, 1800 byte public key), the total cryptographic overhead per sender per second is 34,800 bytes, which is significantly higher than the prior examples of 1200 bytes and 3600 bytes.

In some cases, the above-described systems and techniques can apply to public keys that are publicly broadcast, which can be safely used if their lifetime is short (e.g., shorter than the time it takes for a PQC algorithm to solve/break the private key). In some aspects, the systems and techniques can allow vulnerable public keys to be used safely if they are ever disclosed to a trusted party. For example, a signal preemption certificate can use ECDSA as long as the traffic signal offering preemption services is trustworthy and sets up an encrypted channel (e.g., an encrypted logical channel) that the signed preemption message can be sent over. Such a solution can ensure that only trusted signals will see the ECDSA certificate and they can be trusted not to attempt to break it.

In some aspects, an enrollment certificate, a long-lived certificate used to request application certificates, can be based on ECDSA and sent only over encrypted communications to the CA that will issue the certificate. In some cases, in a V2X Security Credential Management System (SCMS), the enrollment certificate can be sent to the Registration Authority rather than directly to the CA due to how roles are decomposed in the certificate management functional architecture. In such cases, the enrollment certificate may be sent encrypted to SCMS components. In both these cases, there may be cryptographic overhead from setting up the encrypted channel that outweighs the gain in using an ECDSA signature, because the encryption will have to be post-quantum (as otherwise an attacker could break the encryption, obtain the ECDSA certificate, and then break the ECDSA certificate). However, using ECDSA certificates may still have benefit in reducing total traffic if the connection should be encrypted and thus the encryption overhead will be incurred in any case, rather than just being incurred to protect the certificate. Using the ECDSA certificates may also be beneficial where, within the encrypted session, multiple signatures and/or certificates will be sent. In some aspects, if the receiver is trusted, the sender and the receiver can perform a key agreement protocol (for establishing a secure channel) using classical cryptographic algorithms and once the sender and receiver have agreed on the symmetric key, both the sender and receiver can delete all the previous messages from the key agreement protocol.

In some aspects, all quantum-vulnerable cryptographic material can be stored in such a way that it is inaccessible to an attacker, for example by encrypting with a storage master key that is not quantum vulnerable (e.g., symmetric or public-key based).

Additional aspects of the present disclosure are described in more detail below.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

In some cases, a network entity can be implemented in an aggregated or monolithic base station or server architecture, or alternatively, in a disaggregated base station or server architecture, and may include one or more of a central unit (CU), a distributed unit (DU), a radio unit (RU), a Near-Real Time (Near-RT) RAN Intelligent Controller (RIC), or a Non-Real Time (Non-RT) RIC. In some cases, a network entity can include a server device, such as a Multi-access Edge Compute (MEC) device. A base station or server (e.g., with an aggregated/monolithic base station architecture or disaggregated base station architecture) may operate according to one of several RATs in communication with UEs, road side units (RSUs), and/or other devices depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station disaggregated base station architecture) may refer to a single physical TRP or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An RSU is a device that can transmit and receive messages over a communications link or interface (e.g., a cellular-based sidelink or PC5 interface, an 802.11 or WiFi™ based dedicated short-range communication (DSRC) interface, and/or other interface) to and from one or more UEs, other RSUs, and/or base stations. An example of messages that can be transmitted and received by an RSU includes vehicle-to-everything (V2X) messages, which are described in more detail below. RSUs can be located on various transportation infrastructure systems, including roads, bridges, parking lots, toll booths, and/or other infrastructure systems. In some examples, an RSU can facilitate communication between UEs (e.g., vehicles, pedestrian user devices, and/or other UEs) and the transportation infrastructure systems. In some implementations, an RSU can be in communication with a server, base station, and/or other system that can perform centralized management functions.

An RSU can communicate with a communications system of a UE. For example, an intelligent transport system (ITS) of a UE (e.g., a vehicle and/or other UE) can be used to generate and sign messages for transmission to an RSU and to validate messages received from an RSU. An RSU can communicate (e.g., over a PC5 interface, DSRC interface, etc.) with vehicles traveling along a road, bridge, or other infrastructure system in order to obtain traffic-related data (e.g., time, speed, location, etc. of the vehicle). In some cases, in response to obtaining the traffic-related data, the RSU can determine or estimate traffic congestion information (e.g., a start of traffic congestion, an end of traffic congestion, etc.), a travel time, and/or other information for a particular location. In some examples, the RSU can communicate with other RSUs (e.g., over a PC5 interface, DSRC interface, etc.) in order to determine the traffic-related data. The RSU can transmit the information (e.g., traffic congestion information, travel time information, and/or other information) to other vehicles, pedestrian UEs, and/or other UEs. For example, the RSU can broadcast or otherwise transmit the information to any UE (e.g., vehicle, pedestrian UE, etc.) that is in a coverage range of the RSU.

A radio frequency signal or “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

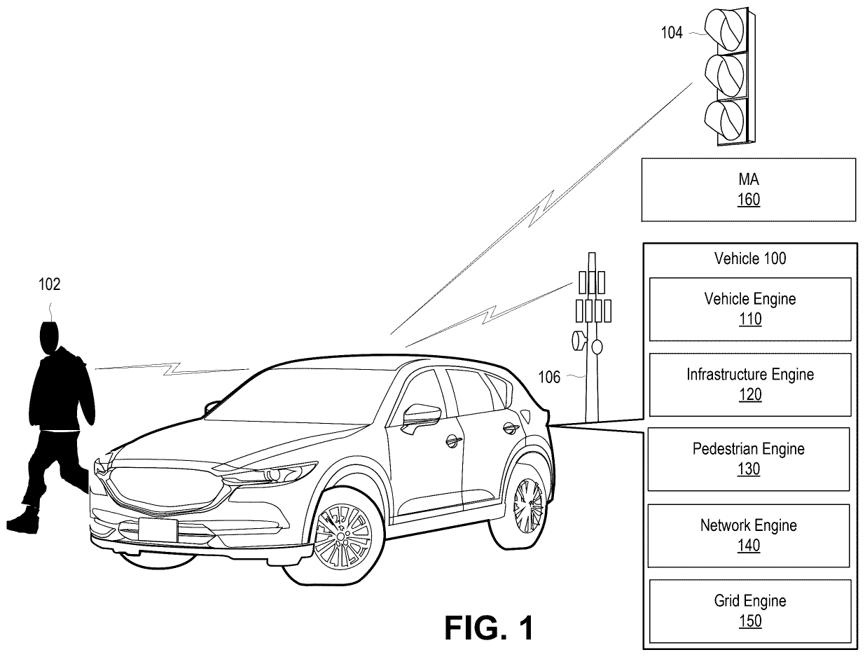

FIG. 1 is a diagram of a vehicle 100 and various V2X functions of the vehicle in accordance with some aspects of the disclosure. In some aspects, the vehicle is configured to form an ad hoc network with different endpoints to safety, payment, and other functions. For example, a V2X network of the vehicle can communicate with a pedestrian 102, traffic infrastructure 104, networks such as wireless communication network 106, and so forth.

A vehicle may include a vehicle communication engine 110. The vehicle communication engine 110 is configured to interact with other vehicles using vehicle-to-vehicle (V2V) functions to enhance safety and traffic management. Non-limiting examples of V2V functions include collision avoidance (e.g., alerting vehicles about potential collisions such as blind spots, intersection risks, etc.), emergency brake warning (e.g., notifications following vehicles when a vehicle suddenly brakes), lane change assistance (e.g., notification to warn drivers when changing lanes if another vehicle is in the blind spot), adaptive cruise control coordination, platooning support (e.g., to enable autonomous coordination of vehicles traveling in close formation or a platoon), overtaking assistance (e.g., passing), intersection movement assistance (e.g., at intersections by sharing vehicle trajectories).

In another aspect, a vehicle can also include infrastructure engine 120 for vehicle-to-infrastructure (V2I) functions. The infrastructure engine 120 is configured to interact with roadside infrastructure for better traffic management and efficiency, such as the traffic infrastructure 104 (e.g., a traffic light, an electronic toll device, parking payment, and so forth). Non-limiting examples of V2I functions include traffic signal priority requests (e.g., enabling emergency and public transport vehicles to preempt traffic signals), red light violation warnings (e.g., an alert of risk of running a red light), dynamic speed limit adjustment (e.g., based on traffic and/or weather conditions), smart traffic light coordination (e.g., to optimize traffic timing based on real-time congestion data), electronic toll collection (e.g., electronic toll payments), road hazard warnings, parking space detection, and railroad crossing alerts.

In another aspect, a vehicle can also include pedestrian engine 130 for vehicle-to-pedestrian (V2P) functions to enhance pedestrian safety by enabling communication between vehicles and vulnerable road users, such as a pedestrian 102. Non-limiting examples of V2P functions include pedestrian collision warnings, bicycle proximity warnings, crosswalk alerts, mobile device alerts for pedestrians, and school zone alerts.

In another aspect, a vehicle can also include network engine 140 for vehicle-to-network (V2N) functions to integrate with cloud services, traffic systems, and other connected devices. Non-limiting examples of V2N functions include traffic congestion updates, weather hazard warnings, remote software updates (e.g., over-the-air software and firmware updates), cloud-based navigation assistance, emergency services notification, and vehicle theft tracking. In some aspects, network engine 140 communicates via the wireless communication network 106.

In another aspect, a vehicle can also include a grid engine 150 for vehicle-to-grid (V2G) functions to enable interaction with power grids, supporting energy efficiency and other sustainability options. Non-limiting examples of V2G functions include smart charging coordination (e.g., vehicles adjust charging schedules based on grid demand), bidirectional energy transfer (e.g., vehicles can supply power back to the grid during peak demand), renewable energy integration, and battery health monitoring.

In some aspects, V2X is an ad hoc local wireless network that can rapidly change based on objects moving in and out of a local area or may change slowly based on objects moving at a similar rate. V2X devices are configured to adapt to these changes rapidly and include different types of messages for different purposes. In some aspects, there are a variety of different messages that the vehicle 100 may implement. One example is a BSM message that identifies vehicle state and behavior. BSM is a core safety message in V2V communication to share real-time vehicle status (e.g., vehicle position, speed, heading, acceleration, brake status, turn signals, etc.). The BSM is broadcast approximately 10 times per second to adjacent devices. Other types of messages include a signal phase and timing (SPaT) signal that provides traffic light information and a roadside unit (RSU) message for communicating current and future traffic signals.

V2X signals enable real-time communication between vehicles, infrastructure, pedestrians, and networks to improve road safety, traffic efficiency, and autonomous driving and control significant aspects of transportation. V2X signals are a prime target for cyber threats like spoofing (e.g., to control traffic lights) and eavesdropping. Cryptography ensures the integrity, authenticity, and confidentiality of V2X messages and prevents malicious actors from injecting false data, intercepting sensitive information, maliciously controlling infrastructure, or cheating payment systems (e.g., ETC). Given the real-time constraints of V2X communication, cryptographic solutions should be both lightweight and highly secure, balancing performance with resilience against emerging threats, including future quantum attacks.

In some aspects, Quantum computers can break classical cryptography (e.g., hard problems in number theory such as integer factorization, discrete logarithms, and elliptic curve cryptography) by efficiently solving problems that are computationally infeasible for classical computers, such as integer factorization and discrete logarithms using Shor's algorithm. For example, quantum computers can break widely used cryptographic schemes like RSA and ECC in polynomial time and render classical cryptography schemes insecure once large-scale quantum computers become available. However, quantum computers will not be publicly available in the foreseeable future due to their cost, complexity, and national security implications. Governments and major research institutions will likely maintain strict control over such technology, limiting access to a few highly regulated entities. Classical cryptographic schemes will continue to be practical for applications like V2X communication. Since V2X networks operate in an open and dynamic environment, mass deployment of quantum-resistant cryptography is challenging, and current classical cryptographic methods provide a balance of security and performance that remains viable as long as quantum computing remains inaccessible to the general public.

In addition, post-quantum cryptography (PQC) introduces a significant challenge for V2X communication due to the large key and signature sizes of quantum-resistant algorithms. V2X systems operate in highly dynamic environments with strict latency and bandwidth constraints since vehicles should exchange safety-critical messages in real-time. Many PQC algorithms, such as lattice-based and code-based schemes, use much larger key sizes as compared to classical cryptographic methods and are computationally expensive. In addition, the larger keys associated with PQC cryptography increase the amount of data transmitted over wireless channels and the added overhead can lead to network congestion, increased transmission latency, and reduced reliability.

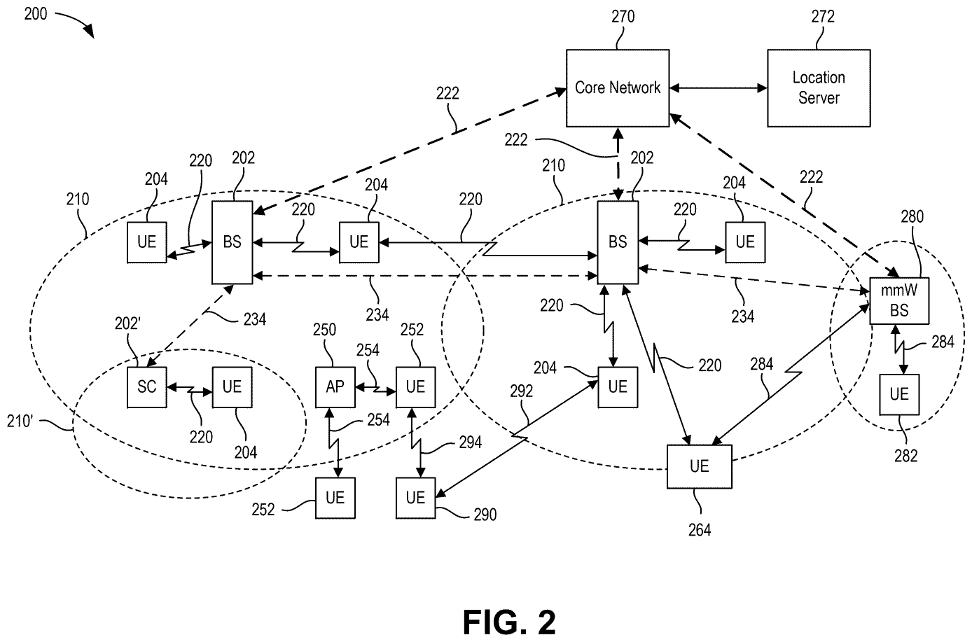

According to various aspects, FIG. 2 illustrates an example wireless communications system 200. The wireless communications system 200 (which may also be referred to as a wireless wide area network (WWAN)) can include various base stations 202 and various UEs 204. In some aspects, the base stations 202 may also be referred to as “network entities” or “network nodes.” One or more of the base stations 202 can be implemented in an aggregated or monolithic base station architecture. Additionally or alternatively, one or more of the base stations 202 can be implemented in a disaggregated base station architecture and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 202 can include macro cell base stations (high power cellular base stations) and/or small cell base stations (low power cellular base stations). In an aspect, the macro cell base station may include eNBs and/or ng-eNBs where the wireless communications system 200 corresponds to a long term evolution (LTE) network, or gNBs where the wireless communications system 200 corresponds to a NR network, or a combination of both, and the small cell base stations may include femtocells, picocells, microcells, etc.

The base stations 202 may collectively form a RAN and interface with a core network 270 (e.g., an evolved packet core (EPC) or a 5G core (5GC)) through backhaul links 222, and through the core network 270 to one or more location servers 272 (which may be part of core network 270 or may be external to core network 270). In addition to other functions, the base stations 202 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 202 may communicate with each other directly or indirectly (e.g., through the EPC or 5GC) over backhaul links 234, which may be wired and/or wireless.

The base stations 202 may wirelessly communicate with the UEs 204. Each of the base stations 202 may provide communication coverage for a respective geographic coverage area 210. In an aspect, one or more cells may be supported by a base station 202 in each coverage area 210. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 210.

While neighboring macro cell base station 202 geographic coverage areas 210 may partially overlap (e.g., in a handover region), some of the geographic coverage areas 210 may be substantially overlapped by a larger geographic coverage area 210. For example, a small cell base station 202′ may have a coverage area 210′ that substantially overlaps with the coverage area 210 of one or more macro cell base stations 202. A network that includes both small cell and macro cell base stations may be known as a heterogeneous network. A heterogeneous network may also include home eNBs (HeNBs), which may provide service to a restricted group known as a closed subscriber group (CSG).

The communication links 220 between the base stations 202 and the UEs 204 may include uplink (also referred to as reverse link) transmissions from a UE 204 to a base station 202 and/or downlink (also referred to as forward link) transmissions from a base station 202 to a UE 204. The communication links 220 may use MIMO antenna technology, including spatial multiplexing, beamforming, and/or transmit diversity. The communication links 220 may be through one or more carrier frequencies. Allocation of carriers may be asymmetric with respect to downlink and uplink (e.g., more or less carriers may be allocated for downlink than for uplink).

The wireless communications system 200 may further include a WLAN AP 250 in communication with WLAN stations (STAs) 252 via communication links 254 in an unlicensed frequency spectrum (e.g., 5 Gigahertz (GHz)). When communicating in an unlicensed frequency spectrum, the WLAN STAs 252 and/or the WLAN AP 250 may perform a clear channel assessment (CCA) or listen before talk (LBT) procedure prior to communicating in order to determine whether the channel is available. In some examples, the wireless communications system 200 can include devices (e.g., UEs, etc.) that communicate with one or more UEs 204, base stations 202, APs 250, etc. utilizing the ultra-wideband (UWB) spectrum. The UWB spectrum can range from 3.1 to 10.5 GHz.

The small cell base station 202′ may operate in a licensed and/or an unlicensed frequency spectrum. When operating in an unlicensed frequency spectrum, the small cell base station 202′ may employ LTE or NR technology and use the same 5 GHz unlicensed frequency spectrum as used by the WLAN AP 250. The small cell base station 202′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 200 may further include a millimeter wave (mmW) base station 280 that may operate in mmW frequencies and/or near mmW frequencies in communication with a UE 282. The mmW base station 280 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHZ with a wavelength of 200 millimeters. The super high frequency (SHF) band extends between 3 GHz and 30 GHz, also referred to as centimeter wave. Communications using the mmW and/or near mmW radio frequency band have high path loss and a relatively short range. The mmW base station 280 and the UE 282 may utilize beamforming (transmit and/or receive) over an mmW communication link 284 to compensate for the extremely high path loss and short range. Further, it will be appreciated that in alternative configurations, one or more base stations 202 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node or entity (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while canceling to suppress radiation in undesired directions.

Transmit beams may be quasi-collocated, meaning that they appear to the receiver (e.g., a UE) as having the same parameters, regardless of whether or not the transmitting antennas of the network node themselves are physically collocated. In NR, there are four types of quasi-collocation (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receiving beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain of other beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Receive beams may be spatially related. A spatial relation means that parameters for a transmit beam for a second reference signal can be derived from information about a receive beam for a first reference signal. For example, a UE may use a particular receive beam to receive one or more downlink reference signals (e.g., positioning reference signals (PRS), tracking reference signals (TRS), phase tracking reference signal (PTRS), cell-specific reference signals (CRS), channel state information reference signals (CSI-RS), primary synchronization signals (PSS), secondary synchronization signals (SSS), synchronization signal blocks (SSBs), etc.) from a network node or entity (e.g., a base station). The UE can then form a transmit beam for sending one or more uplink reference signals (e.g., uplink positioning reference signals (UL-PRS), sounding reference signal (SRS), demodulation reference signals (DMRS),

PTRS, etc.) to that network node or entity (e.g., a base station) based on the parameters of the receive beam.

Note that a “downlink” beam may be either a transmit beam or a receive beam, depending on the entity forming it. For example, if a network node or entity (e.g., a base station) is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a network node or entity (e.g., a base station) is forming the uplink beam, it is an uplink receive beam, and if a UE is forming the uplink beam, it is an uplink transmit beam.

In 5G, the frequency spectrum in which wireless network nodes or entities (e.g., base stations 202/280, UEs 204/282) operate is divided into multiple frequency ranges, FR1 (from 450 to 6000 Megahertz (MHz)), FR2 (from 24250 to 52600 MHz), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 204/282 and the cell in which the UE 204/282 either performs the initial radio resource control (RRC) connection establishment procedure or initiates the RRC connection re-establishment procedure. In some cases, the primary carrier carries all common and UE-specific control channels and may be a carrier in a licensed frequency. A secondary carrier is a carrier operating on a second frequency (e.g., FR2) that may be configured once the RRC connection is established between the UE 204 and the anchor carrier and that may be used to provide additional radio resources. In some cases, the secondary carrier may be a carrier in an unlicensed frequency. The secondary carrier may contain necessary signaling information and signals, for example, UE-specific may not be present in the secondary carrier, since both primary uplink and downlink carriers are typically UE-specific. This means that different UEs 204/282 in a cell may have different downlink primary carriers. The same is true for the uplink primary carriers. The network is able to change the primary carrier of any UE 204/282 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 2, one of the frequencies utilized by the macro cell base stations 202 may be an anchor carrier (or “PCell”) and other frequencies utilized by the macro cell base stations 202 and/or the mmW base station 280 may be secondary carriers (“SCells”). In carrier aggregation, the base stations 202 and/or the UEs 204 may use spectrum up to Y MHz (e.g., 5, 10, 15, 20, 200 MHz) of bandwidth per carrier up to a total of Yx MHz (x component carriers) for transmission in each direction. The component carriers may or may not be adjacent to each other on the frequency spectrum. Allocation of carriers may be asymmetric with respect to the downlink and uplink (e.g., more or less carriers may be allocated for downlink than for uplink). The simultaneous transmission and/or reception of multiple carriers enables the UE 204/282 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In order to operate on multiple carrier frequencies, a base station 202 and/or a UE 204 is equipped with multiple receivers and/or transmitters. For example, a UE 204 may have two receivers, “Receiver 1” and “Receiver 2,” where “Receiver 1” is a multi-band receiver that can be tuned to band (i.e., carrier frequency) ‘X’ or band ‘Y,’ and “Receiver 2” is a one-band receiver tunable to band ‘Z’. In this example, if the UE 204 is being served in band ‘X,’ band ‘X’ would be referred to as the PCell or the active carrier frequency, and “Receiver 1” should tune from band ‘X’ to band ‘Y’ (an SCell) in order to measure band ‘Y’ (and vice versa). In contrast, whether the UE 204 is being served in band ‘X’ or band ‘Y,’ because of the separate “Receiver 2,” the UE 204 can measure band ‘Z’ without interrupting the service on band ‘X’ or band ‘Y.’

The wireless communications system 200 may further include a UE 264 that may communicate with a macro cell base station 202 over a communication link 220 and/or the mmW base station 280 over an mmW communication link 284. For example, the macro cell base station 202 may support a PCell and one or more SCells for the UE 264 and the mmW base station 280 may support one or more SCells for the UE 264.

The wireless communications system 200 may further include one or more UEs, such as UE 290, that connects indirectly to one or more communication networks via one or more device-to-device (D2D) peer-to-peer (P2P) links (referred to as “sidelinks”). In the example of FIG. 2, UE 290 has a D2D P2P link 292 with one of the UEs 204 connected to one of the base stations 202 (e.g., through which UE 290 may indirectly obtain cellular connectivity) and a D2D P2P link 294 with WLAN STA 252 connected to the WLAN AP 250 (through which UE 290 may indirectly obtain WLAN-based Internet connectivity). In an example, the D2D P2P links 292 and 294 may be supported with any well-known D2D RAT, such as LTE Direct (LTE-D), Wi-Fi Direct (Wi-Fi-D), Bluetooth®, and so on.

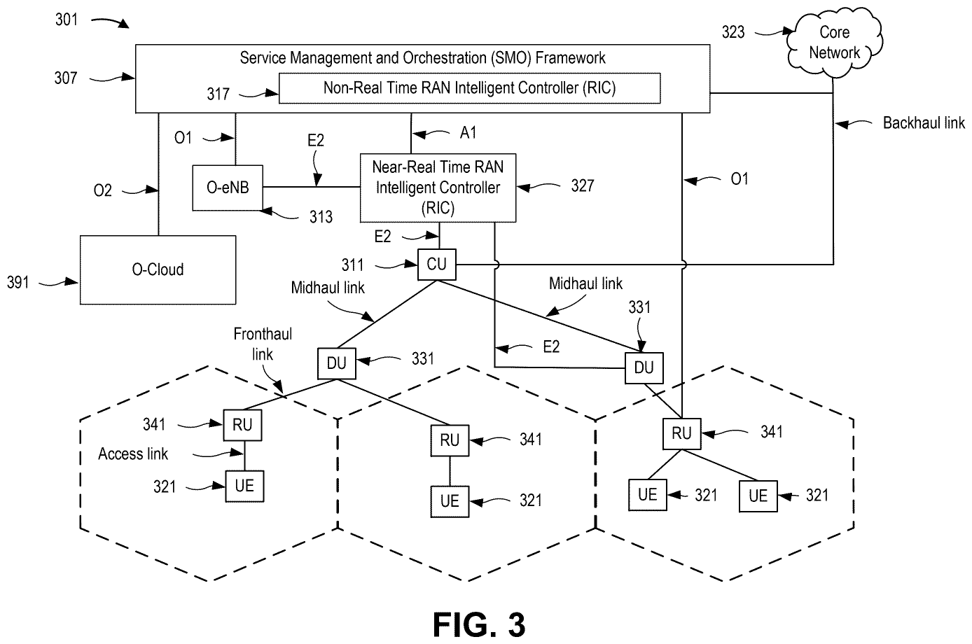

FIG. 3 is a diagram illustrating an example of a disaggregated base station architecture, which may be employed by the disclosed system for event-based network and blockchain formation, in accordance with some examples. Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, AP, a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU can also be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

As previously mentioned, FIG. 3 shows a diagram illustrating an example disaggregated base station 301 architecture. The disaggregated base station 301 architecture may include one or more central units (CUs) 311 that can communicate directly with a core network 323 via a backhaul link, or indirectly with the core network 323 through one or more disaggregated base station units (such as a Near-Real Time (Near-RT) RAN Intelligent Controller (RIC) 327 via an E2 link, or a Non-Real Time (Non-RT) RIC 317 associated with a Service Management and Orchestration (SMO) Framework 307, or both). A CU 311 may communicate with one or more distributed units (DUs) 331 via respective midhaul links, such as an F1 interface. The DUs 331 may communicate with one or more radio units (RUs) 341 via respective fronthaul links. The RUs 341 may communicate with respective UEs 321 via one or more RF access links. In some implementations, the UE 321 may be simultaneously served by multiple RUs 341.

Each of the units, i.e., the CUS 311, the DUs 331, the RUs 341, as well as the Near-RT RICs 327, the Non-RT RICs 317, and the SMO Framework 307, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 311 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 311. The CU 311 may be configured to handle user plane functionality (i.e., Central Unit-User Plane (CU-UP)), control plane functionality (i.e., Central Unit-Control Plane (CU-CP)), or a combination thereof. In some implementations, the CU 311 can be logically split into one or more CU-UP units and one or more CU-CP units. The CU-UP unit can communicate bidirectionally with the CU-CP unit via an interface, such as the E1 interface when implemented in an O-RAN configuration. The CU 311 can be implemented to communicate with the DU 331, as necessary, for network control and signaling.

The DU 331 may correspond to a logical unit that includes one or more base station functions to control the operation of one or more RUs 341. In some aspects, the DU 331 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 331 may further host one or more low PHY layers. Each layer (or module) can be implemented with an interface configured to communicate signals with other layers (and modules) hosted by the DU 331, or with the control functions hosted by the CU 311.

Lower-layer functionality can be implemented by one or more RUs 341. In some deployments, an RU 341, controlled by a DU 331, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 341 can be implemented to handle over the air (OTA) communication with one or more UEs 321. In some implementations, real-time and non-real-time aspects of control and user plane communication with the RU(s) 341 can be controlled by the corresponding DU 331. In some scenarios, this configuration can enable the DU(s) 331 and the CU 311 to be implemented in a cloud-based RAN architecture, such as a vRAN architecture.

The SMO Framework 307 may be configured to support RAN deployment and provisioning of non-virtualized and virtualized network elements. For non-virtualized network elements, the SMO Framework 307 may be configured to support the deployment of dedicated physical resources for RAN coverage requirements that may be managed via an operations and maintenance interface (such as an O1 interface). For virtualized network elements, the SMO Framework 307 may be configured to interact with a cloud computing platform (such as an open cloud (O-Cloud) 391) to perform network element life cycle management (such as to instantiate virtualized network elements) via a cloud computing platform interface (such as an O2 interface). Such virtualized network elements can include, but are not limited to, CUs 311, DUs 331, RUs 341 and Near-RT RICs 327. In some implementations, the SMO Framework 307 can communicate with a hardware aspect of a 4G RAN, such as an open eNB (O-eNB) 313, via an O1 interface. Additionally, in some implementations, the SMO Framework 307 can communicate directly with one or more RUs 341 via an O1 interface. The SMO Framework 307 also may include a Non-RT RIC 317 configured to support functionality of the SMO Framework 307.

The Non-RT RIC 317 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 327. The Non-RT RIC 317 may be coupled to or communicate with (such as via an A1 interface) the Near-RT RIC 327. The Near-RT RIC 327 may be configured to include a logical function that enables near-real-time control and optimization of RAN elements and resources via data collection and actions over an interface (such as via an E2 interface) connecting one or more CUs 311, one or more DUs 331, or both, as well as an O-eNB 313, with the Near-RT RIC 327.

In some implementations, to generate AI/ML models to be deployed in the Near-RT RIC 327, the Non-RT RIC 317 may receive parameters or external enrichment information from external servers. Such information may be utilized by the Near-RT RIC 327 and may be received at the SMO Framework 307 or the Non-RT RIC 317 from non-network data sources or from network functions. In some examples, the Non-RT RIC 317 or the Near-RT RIC 327 may be configured to tune RAN behavior or performance. For example, the Non-RT RIC 317 may monitor long-term trends and patterns for performance and employ AI/ML models to perform corrective actions through the SMO Framework 307 (such as reconfiguration via 01) or via creation of RAN management policies (such as A1 policies).

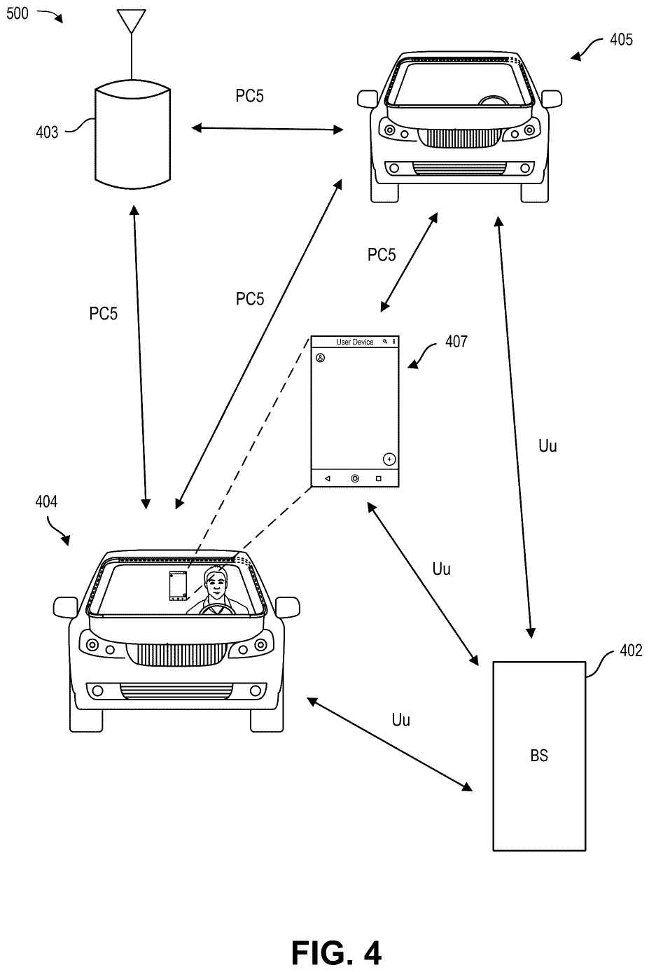

FIG. 4 illustrates examples of different communication mechanisms used by various UEs. In one example of sidelink communications, FIG. 4 illustrates a vehicle 404, a vehicle 405, and an RSU 403 communicating with each other using PC5, DSRC, or other device-to-device direct signaling interfaces. In addition, the vehicle 404 and the vehicle 405 may communicate with a base station (BS) 402 using a network (Uu) interface. The BS 402 can include a gNB in some examples. FIG. 4 also illustrates a user device 407 communicating with the BS 402 using a network (Uu) interface. As described below, functionalities can be transferred from a vehicle (e.g., vehicle 404) to a user device (e.g., user device 407) based on one or more characteristics or factors (e.g., temperature, humidity, etc.). In one illustrative example, V2X functionality can be transitioned from the vehicle 404 to the user device 407, after which the user device 407 can communicate with other vehicles (e.g., vehicle 405) over a PC5 interface (or other device to device direct interface, such as a DSRC interface), as shown in FIG. 4.

While FIG. 4 illustrates a particular number of vehicles (e.g., two vehicles 404 and 405) communicating with each other and/or with RSU 403, BS 402, and/or user device 407, the present disclosure is not limited thereto. For instance, tens or hundreds of such vehicles may be communicating with one another and/or with RSU 403, BS 402, and/or user device 407. At any given point in time, each such vehicle, RSU 403, BS 402, and/or user device 407 may transmit various types of information as messages to other nearby vehicles resulting in each vehicle (e.g., vehicles 404 and/or 405), RSU 403, BS 402, and/or user device 407 receiving hundreds or thousands of messages from other nearby vehicles, RSUs, base stations, and/or other UEs per second.

While PC5 interfaces are shown in FIG. 4, the various UEs (e.g., vehicles, user devices, etc.) and RSU(s) can communicate directly using any suitable type of direct interface, such as an 802.11 DSRC interface, a Bluetooth™ interface, and/or other interface. For example, a vehicle can communicate with a user device over a direct communications interface (e.g., using PC5 and/or DSRC), a vehicle can communicate with another vehicle over the direct communications interface, a user device can communicate with another user device over the direct communications interface, a UE (e.g., a vehicle, user device, etc.) can communicate with an RSU over the direct communications interface, an RSU can communicate with another RSU over the direct communications interface, and the like.

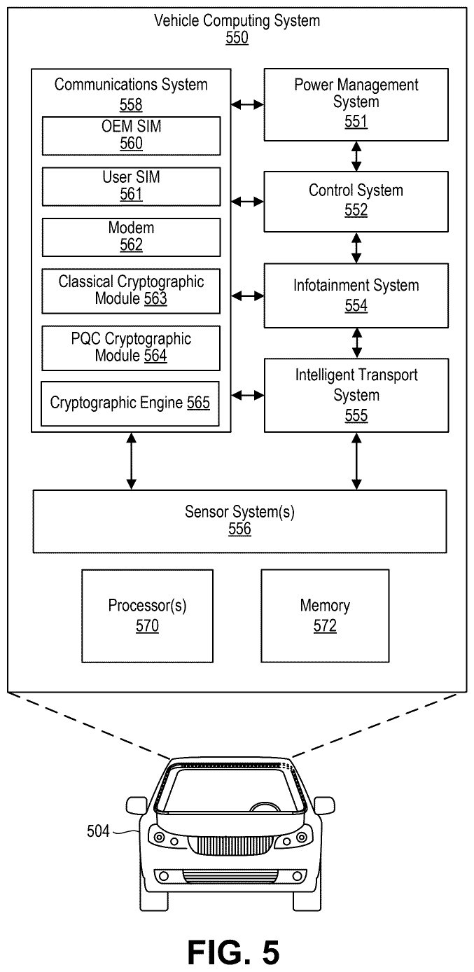

FIG. 5 is a block diagram 500 illustrating an example of a vehicle computing system 550 of a vehicle 504. The vehicle 504 is an example of a UE that can communicate with a network (e.g., an eNB, a gNB, a positioning beacon, a location measurement unit, and/or other network entity) over a Uu interface and with other UEs using V2X communications over a PC5 interface, a C-V2X interface, or other device-to-device direct interface, such as a DSRC interface). As shown, the vehicle computing system 550 can include at least a power management system 551, a control system 552, an infotainment system 554, an intelligent transport system (ITS) 555, one or more sensor systems 556, and a communications system 558. In some cases, the vehicle computing system 550 can include or can be implemented using any type of processor 570 or system on chip, such as one or more central processing units (CPUs), digital signal processors (DSPs), application specific integrated circuits (ASICs), field programmable gate arrays (FPGAs), application processors (APs), graphics processing units (GPUs), vision processing units (VPUs), Neural Network Signal Processors (NSPs), microcontrollers, dedicated hardware, any combination thereof, and/or other processing device or system. The vehicle computing system 550 may also include a memory 572 for storing instructions, data, and so forth.

The control system 552 can be configured to control one or more operations of the vehicle 504, the power management system 551, the computing system 550, the infotainment system 554, the ITS 555, and/or one or more other systems of the vehicle 504 (e.g., a braking system, a steering system, a safety system other than the ITS 555, a cabin system, and/or other system). In some examples, the control system 552 can include one or more electronic control units (ECUs). An ECU can control one or more of the electrical systems or subsystems in a vehicle. Examples of specific ECUs that can be included as part of the control system 552 include an engine control module (ECM), a powertrain control module (PCM), a transmission control module (TCM), a brake control module (BCM), a central control module (CCM), a central timing module (CTM), among others. In some cases, the control system 552 can receive sensor signals from the one or more sensor systems 556 and can communicate with other systems of the vehicle computing system 550 to operate the vehicle 504.

The vehicle computing system 550 also includes a power management system 551. In some implementations, the power management system 551 can include a power management integrated circuit (PMIC), a standby battery, and/or other components. In some cases, other systems of the vehicle computing system 550 can include one or more PMICs, batteries, and/or other components. The power management system 551 can perform power management functions for the vehicle 504, such as managing a power supply for the computing system 550 and/or other parts of the vehicle. For example, the power management system 551 can provide a stable power supply in view of power fluctuations, such as based on starting an engine of the vehicle. In another example, the power management system 551 can perform thermal monitoring operations, such as by checking ambient and/or transistor junction temperatures. In another example, the power management system 551 can perform certain functions based on detecting a certain temperature level, such as causing a cooling system (e.g., one or more fans, an air conditioning system, etc.) to cool certain components of the vehicle computing system 550 (e.g., the control system 552, such as one or more ECUs), shutting down certain functionalities of the vehicle computing system 550 (e.g., limiting the infotainment system 554, such as by shutting off one or more displays, disconnecting from a wireless network, etc.), among other functions.

The vehicle computing system 550 further includes a communications system 558. The communications system 558 can include both software and hardware components for transmitting signals to and receiving signals from a network (e.g., a gNB or other network entity over a Uu interface) and/or from other UEs (e.g., to another vehicle or UE over a PC5 interface, WiFi interface (e.g., DSRC), Bluetooth™ interface, and/or other wireless and/or wired interface). For example, the communications system 558 is configured to transmit and receive information wirelessly over any suitable wireless network (e.g., a 3G network, 4G network, 5G network, WiFi network, Bluetooth™ network, and/or other network). The communications system 558 includes various components or devices used to perform the wireless communication functionalities, including an original equipment manufacturer (OEM) subscriber identity module (referred to as a SIM or SIM card) 560, a user SIM 561, and a modem 562. While the vehicle computing system 550 is shown as having two SIMs and one modem, the computing system 550 can have any number of SIMs (e.g., one SIM or more than two SIMs) and any number of modems (e.g., one modem, two modems, or more than two modems) in some implementations.

A SIM is a device (e.g., an integrated circuit) that can securely store an international mobile subscriber identity (IMSI) number and a related key (e.g., an encryption-decryption key) of a particular subscriber or user. The IMSI and key can be used to identify and authenticate the subscriber on a particular UE. The OEM SIM 560 can be used by the communications system 558 for establishing a wireless connection for vehicle-based operations, such as for conducting emergency-calling (eCall) functions, communicating with a communications system of the vehicle manufacturer (e.g., for software updates, etc.), among other operations. The OEM SIM 560 can be important for supporting services, such as eCall for making emergency calls in the event of a car accident or other emergency. For instance, eCall can include a service that automatically dials an emergency number (e.g., “9-1-1” in the United States, “1-1-2” in Europe, etc.) in the event of a vehicle accident and communicates a location of the vehicle to the emergency services, such as a police department, fire department, etc.

The user SIM 561 can be used by the communications system 558 for performing wireless network access functions in order to support a user data connection (e.g., for conducting phone calls, messaging, infotainment related services, among others). In some cases, a user device of a user can connect with the vehicle computing system 550 over an interface (e.g., over PC5, Bluetooth™, WiFI™ (e.g., DSRC), a universal serial bus (USB) port, and/or other wireless or wired interface). Once connected, the user device can transfer wireless network access functionality from the user device to communications system 558 of the vehicle, in which case the user device can cease performance of the wireless network access functionality (e.g., during the period in which the communications system 558 is performing the wireless access functionality). The communications system 558 can begin interacting with a base station to perform one or more wireless communication operations, such as facilitating a phone call, transmitting and/or receiving data (e.g., messaging, video, audio, etc.), among other operations. In such cases, other components of the vehicle computing system 550 can be used to output data received by the communications system 558. For example, the infotainment system 554 (described below) can display video received by the communications system 558 on one or more displays and/or can output audio received by the communications system 558 using one or more speakers.

A modem is a device that modulates one or more carrier wave signals to encode digital information for transmission, and demodulates signals to decode the transmitted information. The modem 562 (and/or one or more other modems of the communications system 558) can be used for communication of data for the OEM SIM 560 and/or the user SIM 561. In some examples, the modem 562 can include a 4G (or LTE) modem and another modem (not shown) of the communications system 558 can include a 5G (or NR) modem. In some examples, the communications system 558 can include one or more Bluetooth™ modems (e.g., for Bluetooth™ Low Energy (BLE) or other type of Bluetooth communications), one or more WiFi™ modems (e.g., for DSRC communications and/or other WiFi communications), wideband modems (e.g., an ultra-wideband (UWB) modem), any combination thereof, and/or other types of modems.

In some cases, the modem 562 (and/or one or more other modems of the communications system 558) can be used for performing V2X communications (e.g., with other vehicles for V2V communications, with other devices for D2D communications, with infrastructure systems for V2I communications, with pedestrian UEs for V2P communications, etc.). In some examples, the communications system 558 can include a V2X modem used for performing V2X communications (e.g., sidelink communications over a PC5 interface or DSRC interface), in which case the V2X modem can be separate from one or more modems used for wireless network access functions (e.g., for network communications over a network/Uu interface and/or sidelink communications other than V2X communications).

In some aspects, the communications system 558 may include a classical cryptographic module 563 configured to protect content using classical cryptographic algorithms. In some aspects, the classical cryptographic module 563 uses classical cryptographic methods that use number theory, such as Elliptic Curve Cryptography (ECC), for some signals (e.g., a BSM). Hard problems in number theory are the basis of classical cryptography because the algorithms compute in one direction but are extremely hard to reverse without a special key. Their difficulty ensures the security of cryptographic schemes using conventional processors.

The communications system 558 may also include a PQC cryptographic module 564 to support PQC algorithms to protect content for enhanced security against future quantum attacks. The PQC cryptographic module 564 uses hard problems that are believed to be difficult for both classical and quantum computers. One example of a hard problem for PQC includes lattice-based problems, which involve finding specific points or structures within a high-dimensional grid (e.g., lattice) that are computationally hard to solve. An example problem is finding the shortest vector or solving the Learning With Errors (LWE) problem.

By integrating both classical and post-quantum cryptography using the classical encryption module 563 and the PQC encryption module 564, the communications system can maintain backward compatibility while transitioning to quantum-resistant security solutions.

In some cases, it may be beneficial for a malicious actor to use a PQC to obtain benefits, such as forging a traffic signal preemption certificate or forging different types of root certificates. For example, a traffic signal preemption certificate may allow a malicious actor to control traffic lights and travel to a destination without having any red lights. However, malicious actors would benefit very little by forging BSMs that provide a location and a speed of a vehicle. In this way, the vehicle 504 (e.g., the vehicle 100 in FIG. 1) having vehicle computing system 550 uses both classical cryptography and PQC cryptography to secure different aspects of V2X communication. In addition, using both classical cryptography and PQC cryptography minimizes bandwidth consumption to ensure low latency operation until quantum computing is more readily available.

In some aspects, V2X communication defines different signals to be protected based on classical cryptography and PQC cryptography in accordance with emerging industry standards to ensure secure and low-latency communication while maintaining resilience against both classical and quantum threats. For example, the vehicle computing system 550 may receive security and performance OTA updates to ensure the vehicle computing system 550 remains protected against emerging threats and is compatible with evolving encryption standards. OTA updates enable manufacturers to remotely deploy cryptographic updates without requiring physical access to the vehicle. For example, if a type of V2X message protected with classical cryptography is found to be vulnerable to a particular type of attack, OTA updates can reconfigure the V2X message for PQC-based cryptography. In addition, OTA updates can install new algorithms while maintaining backward compatibility, manage certificate revocation, install new certificates, and so forth. OTA updates in the vehicle computing system 550 ensure that legitimate vehicles and infrastructure can securely communicate and prevent unauthorized devices from injecting malicious messages into the V2X network.

In some aspects, transmitted signals in V2X may balance a plurality of factors as shown in Table 1. In some aspects, Table 1 illustrates a plurality of factors and whether the factor would be more beneficial with either classical or PQC cryptography.

TABLE 1

| | Classical: Less | PQC: More |
|---|---|---|
| Factor | Protection | Protection |
| Content Lifespan | Short Lifespan | Long Lifespan |
| Value or Incentive | Low Value | High Value |
| Frequency | High | Low |
| Connection type | Private | Public |
| Control | Internal | External |

In one aspect, the content lifespan of a V2X communication may have less protection when the lifespan of the content is short (e.g., seconds or minutes), and more protection when the lifespan of the content is long (e.g., months or years). A non-limiting example of content with a short lifespan is a BSM message including the speed and position of a vehicle. The BSM message lifespan is short and pertains to operations at that moment in time, and malicious actors would not be able to significantly affect the V2X communication system with forged BSM messages. A non-limiting example of V2X content with a long lifespan is a traffic signal preemption signal, which has a long lifespan (e.g., a year, etc.). Another example of V2X content with a long lifespan is a digital signature certificate for signing other certificates, which can be valid for multiple years.

In some cases, the lifespan of the content can be identified based on the scope of the message. For example, if the message is written to a file system, the scope of the message corresponds to the system and other modules may be able to access it. For example, certificates for digital signatures may be stored in a non-volatile memory. On the other hand, if the content is privately used in a module and stored in non-volatile memory, the scope of the message is limited and may use less protection. In some cases, the content may be a public static variable in a module that is exposed to other modules.

In another aspect, a level of protection applied to content in a V2X communication may vary based on the value or incentive associated with the communication. For example, communications associated with lower value or incentive receive relatively less protection, while communications associated with higher value or incentive receive increased protection. Value refers broadly to any tangible or intangible benefit that may result from transmitting, receiving, altering, or exploiting the communication, including financial value, operational advantage, safety impact, access privileges, or influence over transportation system behavior, and is not limited to monetary considerations. Incentive refers to any motivation or potential advantage (e.g., financial or non-financial) that may encourage a party to generate, modify, spoof, or misuse a communication. For example, V2X communications associated with financial transactions, such as electronic toll collection or automated parking payment, may possess direct monetary value, while other communications may provide non-financial advantages, such as preferential traffic signaling or priority movement through intersections. BSMs, in contrast, may represent comparatively lower-value communications because forging an individual BSM typically provides limited direct benefit, although protection levels may still be determined according to system policy or aggregated risk.

In another aspect, the signal frequency of the content in a V2X communication may have less protection when the signal has high frequency, and more protection when the signal has low frequency. For example, a high frequency message that includes PQC keys adds significant bandwidth consumption and computing time to the devices.

In another aspect, the connection type of the content in a V2X communication may have less protection when the message is private, and more protection when the message is public. For example, an enrollment certificate is issued to a device during an initial registration or enrollment in a V2X network using a secure channel and already has protection. In some aspects, the secure channel may be protected using PQC cryptography. More protection may be needed on public messages, such as a DENM that can are broadcast over a wide area and can cause traffic patterns to shift based on notification of upcoming traffic conditions.

In another aspect, the function of the V2X communication may have less protection when primary purpose of the message is related to an internal state, and more protection when the primary purpose is related to an external state. For example, messages for controlling an external state of another device (e.g., a traffic control signal, a parking door, etc.) may use higher levels of protection. However, messages pertaining to an internal state of the vehicle computing system 550, such as sensor data provided to other devices, should use less protection.

OTA updates may be protected with higher security due to the sensitivity of updates. Improper or spoofed updates may leak sensitive private information and may inject misbehaving functionality in the vehicle computing system 550.

In some aspects, the various standards are associated with the different functions. For example, cooperative perceptive messages are associated with ETSI TS 103 324, SPaT signals are associated with SAE J2735 and ISO 19091, DENM messages are associated with ETSI EN 302 637-3, and BSMs are associated with SAE J2735. In some aspects, the software and firmware of the vehicle computing system 550 can be updated as the various standards evolve to ensure that the signals include the appropriate cryptographic protection. The software and/or firmware associated with the vehicle computing system 550 configures different types of V2X communications to be protected according to a corresponding standard to ensure secure operation within the V2X system.

In another aspect, the vehicle computing system 550 may also include a cryptographic engine 565 that is configured to select a type of encryption in some cases. In some cases, the vehicle computing system 550 may also include various machine learning models, such as an ML model trained for optical flow to assist in various functions such as ADAS, image compression/decompression, etc. In some aspects, an ML model associated with the cryptographic engine 565 can be configured to identify various factors associated with a V2X communication and the cryptographic engine 565 may be configured to select a type of cryptography based on the various factors.

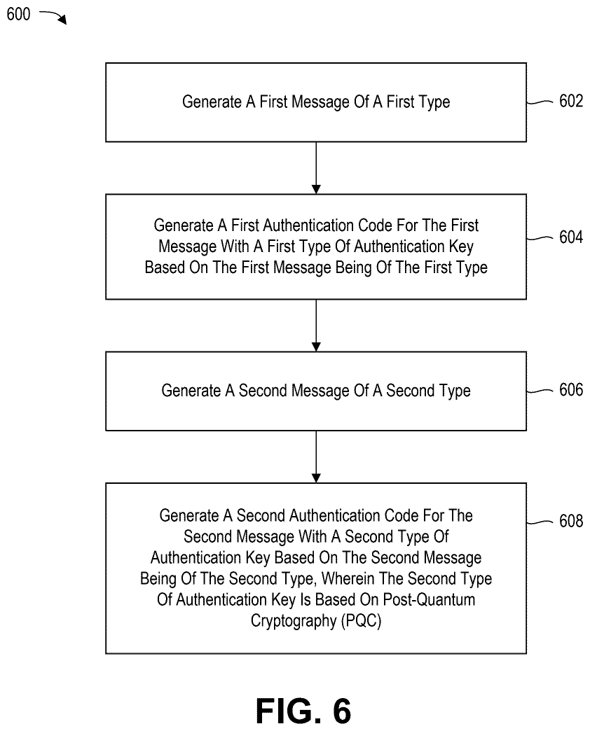

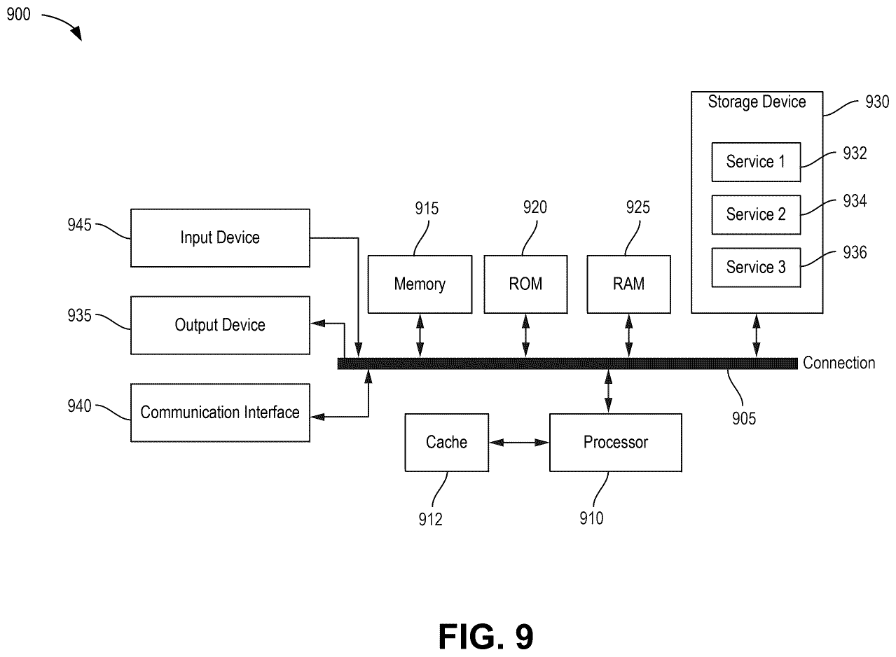

FIG. 6 is a flow diagram illustrating a process for protecting information (e.g., authenticating V2X communications, such as V2X messages) in accordance with some aspects of the disclosure. The process 600 can be performed by a hardware device (or apparatus) or a component (e.g., one or more chipsets, a system-on-chip (SoC) of one or more processors or modules such as one or more central processing units (CPUs), graphics processing units (GPUs), digital signal processors (DSPs), neural processing units (NPUs), neural signal processors (NSPs), microcontrollers, ASICs, FPGAS, programmable logic devices, discrete gates or transistor logic components, discrete hardware components, etc., a machine learning (ML) system such as a neural network model, any combination thereof, and/or other component or system) of the computing device. The operations of the process 600 may be implemented as hardware components that are executed based on software instructions run on one or more processors (e.g., CPU, GPU, DSP, NPU or neural engine, SoC, the processor 910 of FIG. 9, and/or other processor(s)).

In some aspects, at block 602, the computing device may generate a first message of a first type. The first message may be associated with a V2X communication system in connection with at least various functions described herein.

At block 604, the computing device may generate a first authentication code (e.g., a first MAC) for the first message with a first type of authentication key based on the first message being of the first type. For example, the first type of authentication key may be associated with classical cryptography.

In some aspects, as part of block 604, the computing device may evaluate a plurality of factors associated with the first message. Non-limiting examples of factors associated with the first message may include content lifespan (e.g., a scope of the data), a value or incentive associated with the content, a frequency at which the content is transmitted or broadcasted, a connection type, state control of the message. In this case, a state control corresponds to whether the message is associated with controlling an internal state of the computing device or controlling an external state of another apparatus (e.g., a traffic light). Other types of factors can include, for example, a power source (e.g., battery or grid), personally identifiable information, and so forth.

In some aspects, the computing device may, in connection with evaluating the plurality of values, determine a lifespan of content in the first message relative to a time consumed by a quantum computing device. A quantum computing device is a computing device configured to perform computational operations using quantum-mechanical phenomena (e.g., superposition, entanglement, and quantum interference) to enable certain classes of computations (e.g., cryptographic analysis, optimization, and simulation) to be performed more efficiently than with classical computing architectures, to forge a valid instance of the authenticated message. For example, the lifespan may be transient (e.g., a BSM message) or may be stored in non-volatile memory and recalled even after rebooting. In the case of a BSM, while a quantum computing device may be able to forge BSMs protected with classical cryptography, the lifespan of the BSM is significantly shorter than the duration it could take a quantum computing device to mount the attack. In the case of a traffic signal preemption certificate, the lifespan of the traffic signal preemption certificate is significantly longer than the time for the quantum computing device to extract the signing key from the certificate.

In some aspects, the computing device may, in connection with evaluating the plurality of values, determine an incentive for the first message relative to a time consumed by a quantum computing device to forge a valid instance of the first message. An incentive may be intangible (e.g., controlling traffic lights) or have a specific value (e.g., an electronic toll). If the incentive has a value that would warrant employing a quantum computer, the first message should use stronger protection.

In some aspects, the computing device may, in connection with evaluating the plurality of values, determine if the first message is transmitted using a secure connection, such as a connection employing encryption and authentication mechanisms including Transport Layer Security (TLS), Internet Protocol Security (IPsec), a virtual private network (VPN), or another authenticated and encrypted communication channel. For example, the computing device may determine whether the message is provided on a secure channel to prevent public exposure. As an example, during registration of a device, an enrollment certificate is exchanged over a private connection.

In some aspects, the computing device may, in connection with evaluating the plurality of values, determine whether the first message controls traffic infrastructure modes, which refer to operational states or control configurations of traffic management devices (e.g., signal phase changes, preemption or priority operation, timing plan adjustments, flashing or shutdown modes) or other commands that alter the behavior or operation of traffic control infrastructure. For example, stronger protection may be used if the first message changes the state of a traffic infrastructure device (e.g., a traffic light).

In one aspect, the plurality of factors comprises a value of forging the first message and a lifespan of content in the message. In the event the value of forging the first message is high (e.g., forging traffic preemption signals to preempt traffic lights) and the message has a long lifespan, the factors correspond to a higher protection provided with PQC.

At block 606, the computing device may generate a second message of a second type. The second message may be associated with a V2X communication system and have a different or similar function as the first message.

At block 608, the computing device may generate a second authentication code (e.g., a second MAC) for the second message with a second type of authentication key based on the second message being of the second type. The second type of authentication key may be based on post-quantum cryptography (PQC).

In some aspects, the apparatus may include a wireless communication device configured to transmit and receive data with other transportation devices and transportation infrastructure devices.

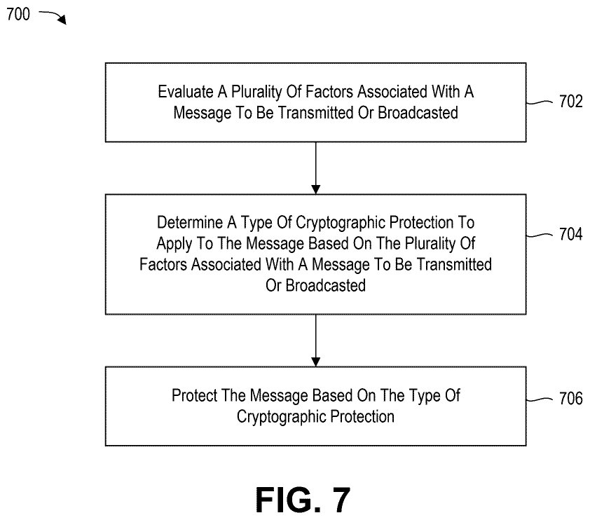

FIG. 7 is a flow diagram illustrating a process for selecting a type of cryptographic protection for V2X communication in accordance with some aspects of the disclosure. The process 700 can be performed by a hardware device (or apparatus) or a component (e.g., one or more chipsets, a system-on-chip (SoC) of one or more processors or modules such as one or more central processing units (CPUs), graphics processing units (GPUs), digital signal processors (DSPs), neural processing units (NPUs), neural signal processors (NSPs), microcontrollers, ASICs, FPGAs, programmable logic devices, discrete gates or transistor logic components, discrete hardware components, etc., a machine learning (ML) system such as a neural network model, any combination thereof, and/or other component or system) of the computing device. The operations of the process 700 may be implemented as hardware components that are executed based on software instructions run on one or more processors (e.g., CPU, GPU, DSP, NPU or neural engine, SoC, the processor 910 of FIG. 9, and/or other processor(s)).

In some aspects, the computing device may dynamically determine the protection type of messages during runtime operation. In other aspects described above, the protection type of messages is configured during design time, but may be updated later based OTA updates and changes to handle challenges, security, and other features of V2X communications.

At block 702, the computing device may evaluate a plurality of factors associated with a message to be transmitted or broadcasted. For example, as part of block 702, the computing device may determine a duration of the content in the message relative to a time consumed by a quantum computing device to forge a valid instance of the message. For example, if a quantum computing device can forge a valid instance of a message that will be valid for a long period of time (e.g., a year), the content warrants stronger protection.

In another example, as part of block 702, the computing device may determine an incentive of the message relative to the time consumed by a quantum computing device to forge a valid instance of the message. For example, the capability to individually control traffic lights has significant value, and being able to avoid electronic tolls has a financial value.

In another example, additional protection may not be warranted when the message is only transmitted over a secure channel. In another example of block 702, the computing device may determine a frequency of the message. Frequent messages may add significant overhead to transmitted messages, which can adversely affect device and network performance. In some aspects, the computing device may also determine whether the message controls other traffic infrastructure modes as part of block 702.

At block 704, the computing device may determine a type of protection to apply to the message based on the plurality of factors used to determine a connection type of the message. For example, high value messages may be protected with PQC and low value messages may be protected using classical cryptography. In other aspects, high value messages may include signatures that are authenticated with PQC and low value messages may include signatures that are authenticated with classical cryptography.

In some aspects, initial standards may apply some of the factors, such as using the lifespan of the content and the value or incentive. For example, the type of cryptography is PQC when the value of forging the message is high and the duration of the content in the message is high. In another example, the type of cryptography is PQC when the value of forging the message is high and the duration of the content in the message is short. Additional factors can be added later as quantum computing devices become more available.

At block 706, the computing device may protect the message based on the type of cryptography. The computing device may also transmit the protected message.

The process 700 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 700 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

In some aspects, parts of the process can be performed by a standards organization, regulatory committee, or compliance authority. For example, a standards organization, regulatory committee, or compliance authority may routinely update standards based on evolution of technical capabilities. For example, as quantum computing becomes more available, the standards organization, regulatory committee, or compliance authority may identify potential security issues and promulgate updated standards to ensure interoperation with legacy and current devices without compromising the overall system. For example, a standards organization may, from time to time, evaluate a plurality of factors associated with a message to be transmitted or broadcasted, and determine a type of authentication to apply to the message based on the plurality of factors. In some aspects, the type of authentication comprises classical cryptography or PQC cryptography.

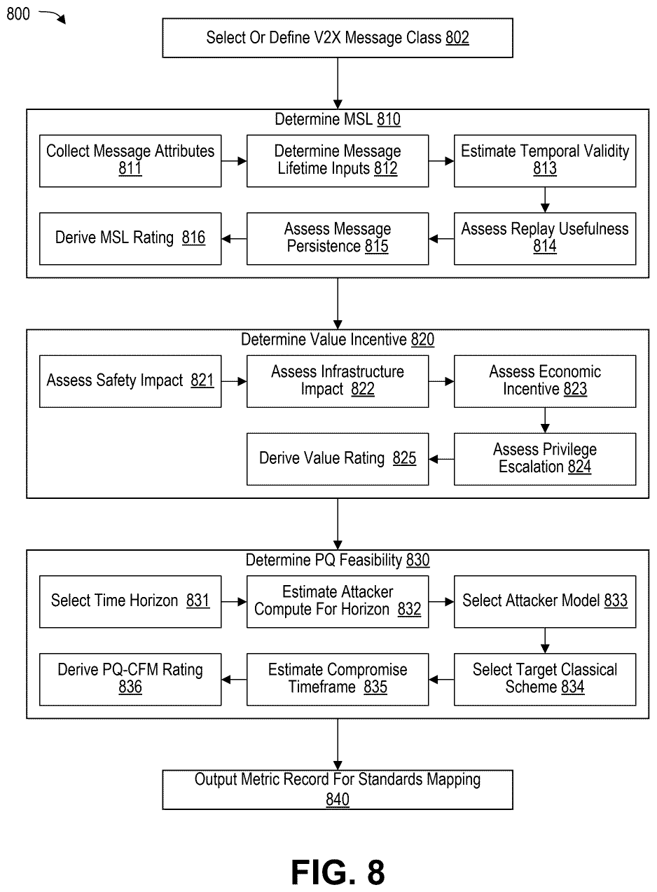

FIG. 8 illustrates an example process 800 for classifying a message to support selection of an cryptographic technique in accordance with some aspects of the disclosure. In some aspects, process 800 is performed by a computing device (or system), a security policy engine, a roadside unit, an onboard unit, or another apparatus that evaluates a plurality of factors associated with a message and identifies a message type based on the plurality of factors. The identified message type is usable to select between a first type of authentication key and a second type of authentication key, the second type of authentication key being based on PQC.

At block 802, the computing device may select a candidate V2X message class. In some aspects, the candidate V2X message class corresponds to a message format or semantic category defined by a V2X stack, such as a safety broadcast, a cooperative awareness broadcast, an infrastructure control message, a credential distribution message, or another message class whose authenticity is to be protected. In some aspects, selecting the candidate V2X message class includes identifying whether the message is transmitted as a broadcast, a multicast, or a unicast, identifying a target recipient population (for example, nearby vehicles, roadside units, or back-end services), and identifying an intended operational mode (for example, direct sidelink communication versus network-assisted distribution).

At block 810, the computing device may determine a message security lifetime (ML). For example, at block 810, the computing device may collect message attributes. In some aspects, the message attributes include a purpose of the message, intended recipients of the message, an expected use of the message, and an operational context in which the message is consumed. For example, a purpose may indicate whether the message is used for immediate safety decisioning, path planning, infrastructure signaling, or credential management, and the expected use may indicate whether the message is used once, used repeatedly, cached for later reference, or used as an input to later authorization decisions. In some aspects, the message attributes also include a sender role (for example, vehicle, emergency vehicle, roadside unit, certificate authority component, or tolling operator), and the sender role is used as an input to later value and privilege assessments.

At block 812, the computing device may determine or receive message lifetime inputs or other information of the message lifetype. In some aspects, the message lifetime inputs include a nominal validity interval associated with the message, a maximum tolerable staleness at a receiver, a safety-relevance interval, and any protocol-level retention behavior. For example, a receiver may accept a safety broadcast if a generation time is within a sub-second or seconds-scale window, while a certificate or revocation artifact may be retained for days, months, or years. In some aspects, message lifetime inputs further include whether the message is expected to be recorded for audit, compliance, training, or incident reconstruction, which can extend the effective exposure window of authenticated content beyond the immediate operational use window.

At block 813, the computing device may estimate temporal validity. In some aspects, temporal validity is estimated as one of sub-second, seconds to minutes, hours to days, or months to years, based on the message attributes collected at block 811 and the message lifetime inputs determined at block 812. For example, a cooperative awareness style message that conveys instantaneous kinematics may have sub-second to seconds temporal validity, while an infrastructure configuration message may have hours to days temporal validity, and a certificate message may have months to years temporal validity. In some aspects, temporal validity is estimated differently for different fields within a message, such as treating a position field as sub-second valid while treating an identifier or authorization indicator as longer-lived, and the computing device may use the longest-lived security-relevant field as the effective temporal validity for subsequent ratings.

At block 814, the computing device may assess replay usefulness. In some aspects, replay usefulness corresponds to an extent to which a previously valid message, if replayed later, remains harmful or beneficial to an attacker, and the replay usefulness may be categorized as low, medium, or high. For example, a replay of a time-sensitive hazard warning may be low usefulness if receivers reject stale timestamps, while a replay of an infrastructure priority or tolling authorization may be high usefulness if it can cause a persistent undesired state or financial loss. In some aspects, replay usefulness further depends on the availability and strength of anti-replay mechanisms, such as sequence numbers, freshness tokens, time synchronization, receiver-side acceptance windows, and whether the receiver performs plausibility checks based on local sensors.

At block 815, the computing device may assess persistence of the message type. In some aspects, persistence indicates whether a message is transient (for example, processed and discarded) or is stored, logged, or cached, which can impact an attacker's opportunity to obtain the message, to attempt offline cryptanalysis, or to later exploit stolen authenticated content. For example, safety broadcast messages may be transient at many receivers but may be logged by fleet operators or crash recorders, while credential and policy artifacts may be routinely cached in memory and in non-volatile storage. In some aspects, the persistence assessment considers whether intermediate network nodes, gateways, or monitoring systems record traffic, and whether those recordings may be accessible to an adversary.

At block 816, the computing device may derive an MSL rating. In some aspects, the MSL rating is derived as low, medium, or high based on temporal validity from block 813, replay usefulness from block 814, and persistence from block 815, and the MSL rating represents an estimated time window over which compromise of authenticity would remain meaningfully harmful. For example, an MSL rating may be low when temporal validity is sub-second and replay usefulness is low and persistence is transient, and an MSL rating may be high when temporal validity extends to months or years, replay usefulness is high, or the message is persistently stored such that offline attacks are plausible. In some aspects, the MSL rating is used as one of the plurality of factors for identifying a message type that maps to a particular authentication key type (for example, classical cryptography versus PQC).

At block 820, the computing device may determine a value incentive for forging credentials. For example, at block 821, the computing device may assess safety impact. In some aspects, safety impact describes whether forging or successfully attacking the message can increase collision risk, create hazards, or degrade safety-related decisioning by receivers. For example, a forged message that induces emergency braking, lane changes, or incorrect right-of-way assumptions can produce collision risk, while a forged message that reports a non-existent hazard can create phantom congestion and unsafe maneuvers. In some aspects, the safety impact assessment considers environmental context such as speed, roadway type, density of traffic, vulnerable road users, and whether automated driving functions consume the message as a control-relevant input.

At block 822, the computing device may assess infrastructure or control impact. In some aspects, infrastructure or control impact includes effects on traffic signals, tolling, lane control, priority services, signal preemption, work-zone management, or other infrastructure-mediated controls. For example, forging a priority request or a signal phase and timing related control message may disrupt intersection operation, and forging a tolling message may cause unauthorized access or billing errors. In some aspects, infrastructure impact includes cascading effects, such as a forged message triggering coordinated corridor timing changes, detours, or emergency response routing, and the assessment may treat such control effects as higher impact due to broader propagation.

At block 823, the computing device may assess economic incentive. In some aspects, economic incentive refers to expected attacker benefit such as fraud, service theft, resource misuse, or monetizable disruption. For example, a forged authorization enabling toll avoidance, charging theft, or paid-priority misuse may present high economic incentive, while a forged low-value cooperative message may present low economic incentive. In some aspects, economic incentive incorporates expected likelihood of exploitation, including whether the message class is commonly deployed, whether access is broadcast and therefore easy to capture at scale, and whether exploitation can be automated or requires proximity.

At block 824, the computing device may assess privilege escalation. In some aspects, privilege escalation refers to whether the message, if forged, can be used to obtain certificates, credentials, trust elevation, or persistent authorization beyond a single message instance. For example, a forged certificate-like message or a message that influences trust lists, revocation status, enrollment, or authorization attributes may allow an attacker to bootstrap additional attacks. In some aspects, privilege escalation is evaluated based on how the message affects receiver trust decisions, such as whether the message enables acceptance of later messages, expands receiver capabilities, changes policy, or affects cryptographic material distribution.

At block 825, the computing device may derive a value rating. In some aspects, the value rating is derived as low, medium, or high based on safety impact from block 821, infrastructure or control impact from block 822, economic incentive from block 823, and privilege escalation from block 824. In some aspects, the value rating represents an estimate of the value of forging or attacking the message, and the value rating is used as part of the plurality of factors for identifying a message type associated with a corresponding authentication approach. For example, high value ratings may correspond to message classes that are candidates for PQC-based authentication or additional protections, while low value ratings may correspond to message classes that remain candidates for classical authentication to reduce overhead under constrained bandwidth and latency conditions.

At block 830, the computing device may determine post-quantum feasibility for the message. At block 831, the computing device may select a time horizon projection window. In some aspects, the time horizon projection window is selected as present, 5 years, 10 years, or another planning interval used for standardization, procurement cycles, or security roadmap development. In some aspects, different time horizons may be selected for different deployment domains, such as shorter horizons for rapidly updated consumer devices and longer horizons for infrastructure deployments with long service lifetimes. The selected time horizon can be used to compare message security lifetime and attacker capability evolution, and can therefore influence whether PQC is applied for a message class even if immediate attacker capability is limited.

At block 832, the computing device may estimate attacker compute capability for the selected horizon. In some aspects, the attacker compute capability includes classical resources and an estimate of cryptographically relevant quantum computer (CRQC) availability, including assumptions regarding qubit counts, error correction, algorithmic improvements, and access constraints. In some aspects, attacker compute capability estimation may be parameterized by attacker class, such as hobbyist, organized criminal group, corporate adversary, or state-level actor, and may include uncertainty bounds. In some aspects, the estimate also accounts for offline analysis enabled by message persistence, such as the attacker collecting large volumes of authenticated traffic for later compromise attempts.

At block 833, the computing device may select an attacker compute model. In some aspects, the attacker compute model is selected from classical-only, limited CRQC, or state-level capabilities, and the selection can represent an operating assumption for a given standards profile or deployment tier. In some aspects, the model selection can vary by geography, threat environment, or criticality of the transportation corridor. In some aspects, the model selection affects downstream feasibility determinations by defining plausible time-to-compromise for classical cryptography and by influencing whether PQC is justified for the evaluated message class.

At block 834, the computing device may select a target classical scheme to be protected. In some aspects, the target classical scheme includes ECC, RSA, or another classical public-key scheme used to authenticate messages in the candidate message class. In some aspects, selecting the target classical scheme further includes identifying key sizes, signature algorithms, certificate chain structures, and whether the message class uses certificates, message authentication codes, or signatures. In some aspects, this selection is aligned with deployed or planned protocol profiles, and the selection supports estimating a compromise timeframe in the selected attacker compute model.

At block 835, the computing device may estimate a compromise feasibility timeframe relative to the selected horizon and attacker compute model. In some aspects, estimating the compromise feasibility timeframe includes estimating an order-of-magnitude time to recover a private key, forge a signature, or otherwise defeat authenticity protections for the target classical scheme in the chosen model. In some aspects, the compromise feasibility timeframe is compared to the MSL rating from block 816, such that if compromise is expected to occur within the message security lifetime, then higher-assurance authentication, such as PQC-based authentication, may be indicated. In some aspects, the estimate incorporates operational considerations including how quickly public keys become known to an attacker, whether keys are rotated, and whether attack success requires real-time computation versus offline computation.

At block 836, the computing device may derive a post-quantum compute feasibility metric (PQ-CFM) rating. In some aspects, the PQ-CFM rating is low, medium, or high feasibility, indicating whether a post-quantum motivated compromise is expected to be feasible within the chosen horizon under the chosen attacker compute model. In some aspects, a high feasibility rating indicates that reliance on the target classical scheme for the message class may be less suitable over the horizon, particularly when combined with medium or high MSL and value ratings. In some aspects, the PQ-CFM rating is used with the MSL rating and value rating as the plurality of factors for identifying a message type and selecting a corresponding authentication key type, including a PQC-based key for at least some message types.

At block 840, the computing device may output a metric record for standards mapping. In some aspects, the metric record includes an MSL indicator derived at block 816, a value indicator derived at block 825, and a PQ-CFM indicator derived at block 836, and the metric record is formatted for use by a standards committee or an implementation profile generator. In some aspects, the metric record is used to map a message class to a protection category that indicates whether classical authentication, PQC-based authentication, hybrid authentication, or conditional authentication is applied. For example, a protection category may specify that high V and high MSL message classes use PQC signatures, while low V and low MSL message classes use classical signatures to limit bandwidth overhead and latency impact, and intermediate classes may use a phased transition or context-dependent selection.

FIG. 9 is a block diagram illustrating an example of a computing system 900 (or device), which may be employed for countermeasures against fault attacks on PQC schemes (e.g., digital signature schemes). In particular, FIG. 9 illustrates an example of computing system 900, which can be for example any computing device making up an internal computing system, a remote computing system, a camera, or any component thereof in which the components of the system are in communication with each other using connection 905. Connection 905 can be a physical connection using a bus, or a direct connection into processor 910, such as in a chipset architecture. Connection 905 can also be a virtual connection, networked connection, or logical connection.

In some aspects, computing system 900 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 900 includes at least one processing unit (CPU or processor) 910 and connection 905 that communicatively couples various system components including system memory 915, such as read-only memory (ROM) 920 and random access memory (RAM) 925 to processor 910. Computing system 900 can include a cache 912 of high-speed memory connected directly with, in close proximity to, or integrated as part of processor 910.

Processor 910 can include any general purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, etc. Computing system 900 can also include output device 935, which can be one or more of a number of output mechanisms. In some instances, multimodal systems can enable a user to provide multiple types of input/output to communicate with computing system 900.

Computing system 900 can include communications interface 940, which can generally govern and manage the user input and system output. The communication interface may perform or facilitate receipt and/or transmission of wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 940 may also include one or more range sensors (e.g., LiDAR sensors, laser range finders, RF radars, ultrasonic sensors, and infrared (IR) sensors) configured to collect data and provide measurements to processor 910, whereby processor 910 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, an EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 930 can include software services, servers, services, etc., that when the code that defines such software is executed by the processor 910, it causes the system to perform a function. In some aspects, a hardware service that performs a particular function can include the software component stored in a computer-readable medium in connection with the necessary hardware components, such as processor 910, connection 905, output device 935, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. For example, concurrent operation involves multiple tasks being performed independently over time and not necessarily simultaneously, while parallel operations involve multiple tasks executing simultaneously, such as on multiple processors or cores. In addition, the order of the operations may be re-arranged. A process is terminated when its operations are completed but may have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“s”) and greater than or equal to (“>”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as RAM such as synchronous dynamic random access memory (SDRAM), ROM, non-volatile random access memory (NVRAM), EEPROM, flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more DSPs, general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative Aspects of the present disclosure include:

Aspect 1. An apparatus comprising: a memory; and a processor coupled to the memory and configured to: generate a first message of a first type; generate a first authentication code for the first message with a first type of authentication key based on the first message being of the first type; generate a second message of a second type; and generate a second authentication code for the second message with a second type of authentication key based on the second message being of the second type, wherein the second type of authentication key is based on PQC.

Aspect 2. The apparatus of Aspect 1, wherein the first type of authentication key is based on classical cryptography.

Aspect 3. The apparatus of any of Aspects 1 to 2, further comprising a wireless communication device configured to transmit and receive data with other transportation device and transportation infrastructure devices.

Aspect 4. The apparatus of any of Aspects 1 to 3, wherein the processor is configured to: evaluate a plurality of factors associated with the first message; and identify whether the first message is associated with the first type based on the plurality of factors.

Aspect 5. The apparatus of Aspect 4, wherein the processor is configured to: determine a lifespan of content in the first message relative to a time consumed by a quantum computing device to forge a valid instance of the first message.

Aspect 6. The apparatus of any of Aspects 4 to 5, wherein the processor is configured to: determine an incentive of the first message relative to a time consumed by a quantum computing device to forge a valid instance of the first message.

Aspect 7. The apparatus of any of Aspects 4 to 6, wherein the processor is configured to: determine if the first message is transmitted using a secure connection.

Aspect 8. The apparatus of any of Aspects 4 to 7, wherein the processor is configured to: determine whether the first message controls traffic infrastructure modes.

Aspect 9. The apparatus of any of Aspects 4 to 8, wherein the plurality of factors comprises a value of forging the first message and a lifespan of content in the first message.

Aspect 10. The apparatus of any of Aspects 1 to 9, wherein the second message includes a digital certificate including at least one public key for validating authentication codes on messages received after the second message.

Aspect 11. A method of an apparatus for communicating in a transportation system network comprising: generating a first message of a first type; generating a first authentication code for the first message with a first type of authentication key based on the first message being of the first type; generating a second message of a second type; and generating a second authentication code for the second message with a second type of authentication key based on the second message being of the second type, wherein the second type of authentication key is based on PQC.

Aspect 12. The method of Aspect 11, wherein the first type of authentication key is based on classical cryptography.

Aspect 13. The method of any of Aspects 11 to 12, further comprising transmitting and receiving data with other transportation device and transportation infrastructure devices.

Aspect 14. The method of any of Aspects 11 to 13, further comprising evaluating a plurality of factors associated with the first message; and identifying whether the first message is associated with the first type based on the plurality of factors.

Aspect 15. The method of Aspect 14, further comprising: determining a lifespan of content in the first message relative to a time consumed by a quantum computing device to forge a valid instance of the first message.

Aspect 16. The method of any of Aspects 14 to 15, further comprising: determining an incentive of the first message relative to a time consumed by a quantum computing device to forge a valid instance of the first message.

Aspect 17. The method of any of Aspects 14 to 16, further comprising: determining if the first message is transmitted using a secure connection.

Aspect 18. The method of any of Aspects 14 to 17, further comprising: determining whether the first message controls traffic infrastructure modes.

Aspect 19. The method of any of Aspects 14 to 18, wherein the plurality of factors comprises a value of forging the first message and a lifespan of content in the first message.

Aspect 20. The method of any of Aspects 11 to 19, wherein the second message includes a digital certificate including at least one public key for validating authentication codes on messages received after the second message.

Aspect 21. A non-transitory computer-readable medium having stored thereon instructions that, when executed by at least one processor, cause the at least one processor to perform operations according to any of Aspects 11 to 20.

Aspect 22. An apparatus for performing a function, comprising one or more means for performing operations according to any of Aspects 11 to 20.

Aspect 23. A method, comprising: evaluating a plurality of factors associated with a message to be transmitted or broadcasted; and determining a type of authentication to apply to the message based on the plurality of factors, wherein the type of authentication comprises classical cryptography or PQC cryptography.

Aspect 24. The method of Aspect 23, wherein evaluating the plurality of factors associated with the first message comprises: determine a lifespan of content in the first message relative to a time consumed by a quantum computing device to forge a valid instance of the first message.

Aspect 25. The method of any of Aspects 23 to 24, wherein evaluating the plurality of factors associated with the first message comprises: determine if the first message is transmitted using a secure connection.

Aspect 26. The method of any of Aspects 23 to 25, wherein evaluating the plurality of factors associated with the first message comprises: determining whether the first message controls traffic infrastructure modes.

Aspect 27. The method of any of Aspects 23 to 26, wherein evaluating the plurality of factors associated with the first message comprises: determining whether the message controls other traffic infrastructure modes.

Aspect 28. The method of any of Aspects 23 to 27, wherein the plurality of factors comprises a value of forging the first message and a lifespan of content in the first message.

Aspect 29. The method of any of Aspects 23 to 28, further comprising: generate an authentication code for the message based on the type of authentication; and transmitting the message and the authentication code.

Aspect 30. The method of any of Aspects 23 to 29, further comprising: outputting a standard associated with an apparatus for interacting with other apparatuses in a communication system, wherein the standard includes the type of authentication to apply to at least or portion of messages.

Aspect 31. An apparatus for performing a function, the apparatus comprising: a memory; and a processor coupled to the memory and configured to perform operations according to any of Aspects 23 to 30.

Aspect 32. A non-transitory computer-readable medium having stored thereon instructions that, when executed by at least one processor, cause the at least one processor to perform operations according to any of Aspects 23 to 30.

Aspect 33. An apparatus for performing a function, comprising one or more means for performing operations according to any of Aspects 23 to 30.

What is claimed is:

1. An apparatus comprising:
a memory; and
a processor coupled to the memory and configured to:
generate a first message of a first type;
generate a first authentication code for the first message with a first type of authentication key based on the first message being of the first type;
generate a second message of a second type; and
generate a second authentication code for the second message with a second type of authentication key based on the second message being of the second type, wherein the second type of authentication key is based on post-quantum cryptography (PQC).

2. The apparatus of claim 1, wherein the first type of authentication key is based on classical cryptography.

3. The apparatus of claim 1, wherein the processor is configured to:
evaluate a plurality of factors associated with the first message at a point in time; and
identify whether the first message is associated with the first type based on the plurality of factors.

4. The apparatus of claim 3, wherein the processor is configured to:
determine a lifespan of content in the first message relative to a time consumed by a quantum computing device to forge a valid instance of the first message at the point in time.

5. The apparatus of claim 3, wherein the processor is configured to:
determine an incentive of the first message relative to a time consumed by a quantum computing device to forge a valid instance of the first message at the point in time.

6. The apparatus of claim 3, wherein the processor is configured to:
determine if the first message is transmitted using a secure connection at the point in time.

7. The apparatus of claim 3, wherein the processor is configured to:
determine whether the first message controls traffic infrastructure modes at the point in time.

8. The apparatus of claim 3, wherein the plurality of factors comprises a value of forging the first message and a lifespan of content in the first message at the point in time.

9. The apparatus of claim 1, wherein the second message includes a digital certificate including at least one public key for validating authentication codes on messages received after the second message.

10. A method comprising:
generating a first message of a first type;
generating a first authentication code for the first message with a first type of authentication key based on the first message being of the first type;
generating a second message of a second type; and
generating a second authentication code for the second message with a second type of authentication key based on the second message being of the second type, wherein the second type of authentication key is based on post-quantum cryptography (PQC).

11. The method of claim 10, wherein the first type of authentication key is based on classical cryptography.

12. The method of claim 10, further comprising:
evaluating a plurality of factors associated with the first message at a point in time; and
identifying whether the first message is associated with the first type based on the plurality of factors.

13. The method of claim 12, further comprising:
determining a lifespan of content in the first message relative to a time consumed by a quantum computing device to forge a valid instance of the first message at the point in time.

14. The method of claim 12, further comprising:
determining an incentive of the first message relative to a time consumed by a quantum computing device to forge a valid instance of the first message at the point in time.

15. The method of claim 12, further comprising:
determining if the first message is transmitted using a secure connection at the point in time.

16. The method of claim 12, further comprising:
determining whether the first message controls traffic infrastructure modes at the point in time.

17. The method of claim 12, wherein the plurality of factors comprises a value of forging the first message and a lifespan of content in the first message at the point in time.

18. The method of claim 12, wherein the second message includes a digital certificate including at least one public key for validating authentication codes on messages received after the second message.

19. A method, comprising:
evaluating a plurality of factors associated with a message to be transmitted or broadcasted; and
determining a type of authentication to apply to the message based on the plurality of factors, wherein the type of authentication comprises classical cryptography or PQC cryptography.

20. The method of claim 19, wherein evaluating the plurality of factors associated with the message comprises:
determine a lifespan of content in the message relative to a time consumed by a quantum computing device to forge a valid instance of the message.
